(19) United States
(12) Patent Application Publication
(10) Pub. No.: US 2026/0155779 A1
(43) Pub. Date: Jun. 4, 2026

(54) Reach Free Mid-Clamps for Attaching Solar Panel Frames to Rails

(71) Applicant: Enstall US, Inc., Hayward, CA (US)

(72) Inventors: Roger Pedlar, Phoenix, AZ (US); Duane Menton, Vallejo, CA (US); Aaron Williamson, Laveen, AZ (US)

(21) Appl. No.: 19/454,656

(22) Filed: Jan. 21, 2026

Related U.S. Application Data
(63) Continuation-in-part of application No. PCT/US25/38501, filed on Jul. 21, 2025.
(60) Provisional application No. 63/673,632, filed on Jul. 19, 2024.

(51) Int. Cl. H02S 30/00; F16M 13/02

(52) U.S. Cl. CPC H02S 30/00; F16M 13/02

(57) ABSTRACT

A mid-clamp for attaching solar module frames to a rail has an upper portion with an angled clamping surface, so that tightening of the clamp after insertion of a first module frame leaves the clamp with appropriate torque and clearance. Thereby, a second solar module frame may be inserted in the clearance on an opposite side of the clamp, by a rocking-in motion, without the need for further manual tightening of the clamp by the installer. Clamps with friction plates, vertical legs, ledges, and a clamp that utilizes mounting strips which attach to module frames are also disclosed. As well, a clamp with a two-part, spring-loaded upper portion and a clamp with a two-part hinged arrangement are disclosed. A method of attaching a second solar module frame to rails, without reaching over an already installed first module frame, is also disclosed.

### CROSS REFERENCE TO RELATED APPLICATIONS

This application is a Continuation-in-Part of International Patent Application No. PCT/US25/38501, filed Jul. 21, 2025, and claims the benefit of U.S. Provisional Patent Application No. 63/673,632, filed Jul. 19, 2024, the disclosures of which are hereby incorporated by reference in their entireties.

### BACKGROUND OF THE INVENTION

### Field of the Invention

The invention relates to devices for attaching solar panels to a mounting surface, such as a roof, and, more particularly, to clamps for securing solar panel frames to rails.

### Description of Related Art

It has been known to attach solar panels to a roof using a system of mounts, rails, and clamps. The solar panels, also known as photovoltaic (PV) modules, are generally rectangular and supported around all four edges of the PV module with a metallic frame. These module frames have a profile which may be engaged by a clamp, and the clamp is secured to a rail. The rail is, in turn, secured to a mounting surface, such as a composite shingle, tile, or membrane roof, with a mount or roof attachment. One such system may be seen in U.S. Pat. No. 12,003,206.

In installation, after the roof attachments have been secured to the roof and the rails have been secured to the roof attachments, the solar panels are then placed. Specifically, a first solar panel is laid across two rails, and a near edge of the solar panel is secured to the rails using clamps. These clamps that secure a near edge of the first module are called end clamps as there is a module on only one side of the clamp. The clamps, on a lower end, are secured to the rail, and on an upper end they engage the module frame. The clamps are tightened. A second solar panel is next laid adjacent the first solar panel, across the same two rails. The near edge of the module frame on the second solar panel is adjacent the far edge of the module frame on the first-laid solar panel. These two adjacent module frame edges are typically secured to the rails by one clamp, called a mid-clamp. The mid-clamp on its lower end is secured to the rail, and on an upper end, the mid-clamp straddles the two adjacent module frames.

Heretofore, the mid-clamps had to be tightened after the two adjacent module frames were placed. This requires an awkward reaching by the installer over the span of one of the first-laid or second laid solar panels in order to engage a tool with the mid-clamp to tighten it. During this reaching over the solar panel to tighten the clamp the installer applies body weight on the module and this can cause micro-cracking of the solar cells and reduce the output and long term production of the solar panels. Furthermore, it is often necessary to have two installers to install the solar modules. One to hold modules in place and the other to tighten the two mid-clamps between adjacent module frames and to ensure proper placement, torque and levelling.

It is an object of the invention to provide a mid-clamp which eliminates reaching for tightening, and to facilitate proper installation of two adjacent solar panel module frames by a single installer. It is a further object to facilitate the nearest edge of a second module to be clamped without having to reach over the first or second module.

### SUMMARY OF THE INVENTION

These objects are achieved by the invention described herein. After a first solar panel module is placed on rails and clamps are tightened on the near edge of the first module, the first module is secured and held in place on the rails. Then the clamp is placed on a far edge of the first module and secured to the rail. The clamp may start off level or slightly inclined in a first direction. When the clamp is tightened onto the first module (within a desired torque range), the clamp will tip slightly, closing the gap between a top surface of the rail and a bottom surface of the clamp for a second module to slightly less than the height of the module. The second solar panel module is then inserted and rocked into the clamp, it is compressed between the bottom surface of the clamp and the top surface of the rail, achieving the desired clamp force. The clamp load secures a near edge of the module frame of the second solar panel, without the need for further manual tightening of the clamp by the installers. This eliminates the need to reach over the PV modules to tighten the clamps.

A friction plate may be carried on the clamp, which rests on the rail and provides friction reduction and optionally a pocket to further facilitate insertion of the module into the clamp. The friction plate may have cross members, with a window and runners, or the plate may have a raised section and two standoffs.

The lower clamp portion may have a ledge which may stick up slightly above upper edges of the rail; or the ledge may have a raised portion, such as a ridge or a flat, which protrudes about the top edge of the rail.

Many rail types may be used with the invention, including outside clicking rails, inside clicking rails, open top (or open channel) rails, or rails with a slot or track in the top of the rail. One embodiment of the invention does not require the inclined bottom surface on the upper clamp portion, instead relying on a spring loaded, two-part upper clamp portion.

The invention may be further summarized with the following clauses:
Clause 1. A clamp for attaching a solar panel module frame to a rail, comprising:
an upper clamp portion;
a lower clamp portion;
a fastener connecting the upper clamp portion with the lower clamp portion,
the upper clamp portion having a top surface and a bottom surface,
at least a portion of the bottom surface being coincident with a plane which is inclined with respect to horizontal,
the lower clamp portion being configured to engage with a rail,
wherein when a first solar panel module frame is inserted between the upper clamp portion and the rail, and said fastener is tightened to a desired torque, the bottom surface of the upper clamp portion tilts slightly so that said plane moves to a slightly declined orientation with respect to horizontal, creating a clearance below the declined bottom surface, which clearance is less than a height of the second solar module frame;
and further wherein when the second solar panel module frame is inserted between the upper clamp portion and the rail on a side of said fastener which is opposite the first solar panel module frame, said solar panel module frame exerts an upward force on the upper clamp portion, thereby bringing said plane into coincidence with horizontal, and
the compressive forces of the upper clamp portion and the height of the second solar module frame cooperate to secure the second solar panel module frame in the clamp without further tightening of the fastener.
Clause 2. The clamp of clause 1, further including a leg extending downward from said bottom surface.
Clause 3. The clamp of clause 1 or 2, wherein an angle at which said plane is inclined with respect to horizontal is between 0.25° and 7°.
Clause 4. The clamp of clause 1, 2 or 3 wherein said second module frame rests directly on said rail after said insertion between the upper clamp portion and the rail.
Clause 5. The clamp of any of clauses 1-4, wherein said bottom surface is provided with serrations and a bonding pin.
Clause 6. The clamp of any of clauses 1-3 or 5, further including a friction plate which rests on or above said rail.
Clause 7. The clamp of clause 6, wherein said friction plate includes a cross member which defines a pocket between the clamp and the cross member.
Clause 8. The clamp of any of clauses 1-7, wherein said upper clamp portion has a male part and a female part, and a spring washer inserted into the female part along with and adjacent to the male part.
Clause 9. The clamp of clause 6, wherein said friction plate is a bent piece of sheet metal having a raised section.
Clause 10. The clamp of clause 9, wherein said raised section is dome shaped.
Clause 11. The clamp of clause 9, wherein said raised section engages with a bottom surface of the second module frame, when said second module frame is inserted in said clearance between said friction plate and the bottom surface of said upper clamp portion.
Clause 12. The clamp of clause 9, further including a pocket defined between the raised potion and the lower clamp portion.
Clause 13. The clamp of any of clauses 1-5 or 7-8, wherein said rail is open-topped, and further including a ledge on the bottom clamp portion which traverses the width of the opening in the top of the rail.
Clause 14. The clamp of clause 13, wherein said second solar module frame engages said ledge when the second solar module frame is inserted in said clearance below the upper clamp portion.
Clause 15. The clamp of clause 14, wherein said rail has outer top edges on either side of said ledge, and at least a part of a top surface on said ledge is above said outer top edges of the rail.
Clause 16. The clamp of clause 15, further including a pocket defined in the top surface of said ledge, near a proximal end of said ledge.
Clause 17. The clamp of clause 9, further including standoffs on opposite sides of a distal end of said plate.
Clause 18. The clamp of clause 7 further including runners on opposite sides of said plate and paralleling said rail.
Clause 19. The clamp of clause 1, wherein said lower clamp portion has a tapered shape which is wider at the bottom and narrower at the top.
Clause 20. A clamp for attaching a solar panel module frame to a rail, comprising:
an upper clamp portion;
a lower clamp portion;
a fastener connecting the upper clamp portion with the lower clamp portion,
the upper clamp portion having a top surface and a bottom surface, and further having male and female portions;
a resilient element positioned in said female portion adjacent and in contact with said male portion;
the lower clamp portion being configured to engage with a rail,
wherein when a first solar panel module frame is inserted between the upper clamp portion and the rail, and said fastener is tightened to a desired torque, the bottom surface of the male portion of the upper clamp portion moves to a position creating a clearance below the bottom surface, which clearance is less than a height of the second solar module frame;
and further wherein when the second solar panel module frame is inserted between the upper clamp portion and the rail on a side of said fastener which is opposite the first solar panel module frame, said solar panel module frame exerts an upward force on the male portion of the upper clamp portion, thereby causing an equal and opposite force imparted by said resilient element, and
the compressive forces of the male portion of the upper clamp portion and the height of the second solar module frame cooperate to secure the second solar panel module frame in the clamp without further tightening of the fastener.
Clause 21: A method for attaching solar panel modules to a rail, using a mid-clamp, comprising the steps of:
(a) securing a first solar panel module to a rail at a first module edge frame;
(b) positioning a mid-clamp on said first solar panel at a second module edge frame opposite said first module edge frame;
(c) tightening said mid-clamp to a desired torque, thereby securing said mid-clamp to the rail and tilting a mid-clamp surface opposite said rail to create a clearance between said surface and said rail, said clearance being more narrow than a height of said second module edge frame;
(d) inserting a second solar panel module into said clearance, by rocking-in a third module edge frame so that said third module edge frame exerts an upward force on said mid-clamp surface, thereby bringing said surface into a plane which is coincident with horizontal, and
the compressive forces of the mid-clamp surface and the height of the third module edge frame cooperating to secure the second solar panel module frame in the mid-clamp without further tightening of the mid-clamp.
Clause 22: The method of clause 21 wherein said tightening is carried out using a fastener on said mid-clamp.
Clause 23. The method of clause 21 wherein, prior to step (c), said mid-clamp surface is inclined with respect to horizontal, and after step (c), said mid-clamp surface is declined with respect to horizontal.
Clause 24. The method of clause 21, wherein said desired torque is in the range of 50-200 inch-pounds.
Clause 25. The method of clause 23, wherein an angle at which said surface is inclined and/or declined with respect to horizontal is between 0.25° and 7°.
Clause 26. The clamp of clause 6, wherein said friction plate includes raised portions which engage the bottom surface of module frames to provide a ground bonding connection.
Clause 27. The clamp of clause 26, wherein said raised portions are conical-shaped and open at the top.
Clause 28. The clamp of clause 26, wherein said raised portions are triangle-shaped.
Clause 29. The clamp of clause 28, wherein said raised portions are tapered, with the highest part being closest to the mid-clamp.
Clause 30. The clamp of clause 26, further including runners on opposite sides of said plate and paralleling said rail.
Clause 31. A clamp for attaching a solar panel module frame to a rail, comprising:
an upper clamp portion;
a lower clamp portion;
mounting strips which attach to module frames;
a fastener connecting the upper clamp portion with the lower clamp portion,
the upper clamp portion having a top surface and open slots configured to cooperate with the mounting strips,
the lower clamp portion being configured to engage with a rail,
wherein when a first solar panel module frame with mounting strip attached is inserted between the upper clamp portion open slot and the rail, and said fastener is tightened to a desired torque, said mounting strip is clamped to the rail; and
further wherein when the second solar panel module frame with mounting strip attached is rotated into an opposing open slot in the upper clamp portion, a clamping force is applied between the upper clamp portion open slot and the rail, thereby clamping said mounting strip to the rail without further tightening of the fastener.
Clause 32. Method for attaching solar panel modules to a rail, using a mid-clamp, comprising the steps of:
(a) attaching mounting strips to a second module edge frame of a first solar panel module and a third module edge frame of a second solar panel module;
(b) securing a first solar panel module to a rail at a first module edge frame;
(c) positioning a mid-clamp on said first solar panel mounting strip attached to a second module edge frame opposite said first module edge frame;
(d) tightening said mid-clamp to a desired torque, thereby securing said mounting strip attached to the second module edge frame to the rail; and
(e) inserting a second solar panel module mounting strip attached to a third module edge frame into said mid-clamp opposite said second module edge frame by rocking-in said mounting strip until the second solar panel module is horizontal with respect to the rail so that an upward force is applied to said mid-clamp, thereby clamping said mounting strip to the rail without further tightening of said mid-clamp.
Clause 33. The method of clause 32, wherein said tightening is carried out using a fastener on said mid-clamp.
Clause 34. The method of clause 32, wherein said desired torque is in the range of 50-200 inch-pounds.
Clause 35. A clamp for attaching a solar panel module frame to a rail, comprising:
   a fixed clamp portion;
   a movable clamp portion;
   a lower clamp portion;
   a fastener connecting the fixed clamp portion with the lower clamp portion,
   the fixed clamp portion having a top surface, a bottom surface, and a catch, the bottom surface being horizontal with respect to the rail,
   the movable clamp portion having a top surface, a bottom surface, and a catch, and further being pivotably connected to the fixed portion,
   the lower clamp portion being configured to engage with a rail,
   wherein when a first solar panel module frame is inserted between the bottom surface of the fixed clamp portion and the rail, and said fastener is tightened to a desired torque, the first solar panel module frame is clamped to the rail;
   and further wherein when the second solar panel module frame is inserted between the bottom surface of the movable clamp portion and the rail on a side of said fastener which is opposite the first solar panel module frame, said solar panel module frame exerts a rotational force on the movable clamp portion, thereby bringing said bottom surface into a plane horizontal with respect to the rail and causing the catch to engage the opposing catch on the fixed clamp portion, and
   wherein the engagement of the catch on the movable clamp portion with the catch on the fixed clamp portion causes a clamping force to be maintained on the second solar panel module frame between the bottom surface of the movable clamp portion and the rail without further tightening of the fastener.
Clause 36. The clamp of clause 35, wherein said second module frame rests directly on said rail after said insertion between the movable clamp portion and the rail.
Clause 37. The clamp of clause 35, wherein the bottom surface of the fixed clamp portion and the bottom surface of the movable clamp portion are provided with serrations and a bonding pin.
Clause 38. The clamp of clause 1, wherein the upper clamp portion includes a lowered surface which allows the upper clamp portion to tilt with respect to the fastener.
Clause 39. The clamp of clause 1, wherein the upper clamp portion includes an open slot which allows the upper clamp portion to tilt with respect to the fastener.
Clause 40. The clamp of clause 1, wherein the bottom surface of the upper clamp portion is higher than the central portion of the upper clamp portion.
Clause 41. A clamp for attaching a solar panel module frame to a rail, comprising:
   an upper clamp portion;
   a lower clamp portion;
   a fastener having a head and shank connecting the upper clamp portion with the lower clamp portion,
   the upper clamp portion having a top surface, a bottom surface, a central portion, and a shank clearance slot,
   the lower clamp portion being configured to engage with a rail,
   the top surface having a lowered portion which is opposed from the fastener head to form a gap therebetween,
   wherein when a first solar panel module frame is inserted between the upper clamp portion and the rail, said fastener is tightened to a desired torque;
   and further wherein when the second solar panel module frame is inserted between the upper clamp portion and the rail on a side of said fastener which is opposite the first solar panel module frame, said second solar panel module frame exerts an upward force on the upper clamp portion, thereby tilting the clamp with respect to the shank and narrowing said gap between the fastener head and the lowered portion of the top surface; and
   the compressive forces of the upper clamp portion and the height of the second solar module frame cooperate to secure the second solar panel module frame in the clamp without further tightening of the fastener.
Clause 42. The clamp of clause 41, further including a leg extending downward from said bottom surface.
Clause 43. The clamp of clause 41, wherein the shank clearance slot is open-ended and provides clearance for the upper clamp portion to tilt with respect to the fastener shank.
Clause 44. The clamp of clause 41, wherein the central portion extends below the bottom surface of the upper clamp portion.
Clause 45. The clamp of clause 41, wherein said second module frame rests directly on said rail after said insertion between the upper clamp portion and the rail.
Clause 46. The clamp of clause 41, wherein said bottom surface is provided with serrations and a bonding pin.
Clause 47. The clamp of clause 41, further including a friction plate which rests on or above said rail.
Clause 48. The clamp of clause 47, further including runners on opposite sides of said plate and paralleling said rail.
Clause 49. The clamp of clause 47, wherein said friction plate includes raised portions which engage the bottom surface of module frames to provide a ground bonding connection.
Clause 50. The clamp of clause 49, wherein said raised portions are conical-shaped and open at the top.
Clause 51. The clamp of clause 49, wherein said raised portions are triangle-shaped.
Clause 52. The clamp of clause 51, wherein said raised portions are tapered, with the highest part being closest to the mid-clamp.
Clause 53. The clamp of clause 42, wherein on the bottom surface of the top portion, a first cutout is included adjacent to said central portion.
Clause 54. The clamp of clause 53, further including a second cutout spaced from said first cutout and adjacent to a distal end of said top portion.
Clause 55. The clamp of clause 54, wherein the distal end is characterized by a downwardly extending tip.

### BRIEF DESCRIPTION OF THE DRAWINGS

FIG. 1 is a schematic elevation view, illustrating the operation, in sequential steps, of a mid-clamp and rail with adjoining solar module frames, according to the present invention;

FIG. 2 is an elevation view of a first embodiment of a mid-clamp according to the present invention;

FIG. 3 is a perspective view of the mid-clamp of FIG. 2;

FIG. 4 is an elevation view of a second embodiment of a mid-clamp according to the present invention;

FIG. 5 is a perspective view of the mid-clamp of FIG. 4;

FIG. 6 is an elevation view of a third embodiment of a mid-clamp according to the present invention;

FIG. 7 is a perspective view of the mid-clamp of FIG. 6;

FIG. 8 is a perspective view of a fourth embodiment of a mid-clamp according to the present invention, including a friction plate;

FIG. 9 is a perspective view of a fifth embodiment of a mid-clamp according to the present invention, including an alternative form of friction plate;

FIGS. 10(a)-(c) are a series of elevation views of a mid-clamp according to the present invention, with three different bottom portions suitable to engage three different types of rails;

FIG. 11(a) is a perspective view of another embodiment of a clamp according to the present invention, installed in an open-top rail, with flat ledges;

FIG. 11 (b) is a perspective view of the mid-clamp shown in FIG. 11(a);

FIG. 11(c) is a perspective view of another embodiment of the present invention, similar to the embodiment of FIG. 11(a) but with a hollow downward leg;

FIG. 12 (a) is an elevation view of a mid-clamp according to yet another embodiment of the present invention, mounted on an open-top rail and showing cooperation between the clamp and rail to secure two module frames;

FIG. 12(b) is an end view showing securement of the clamp of FIG. 12(a) into the open-top rail of FIG. 12(a);

FIG. 12(c) is an exploded perspective view of the mid-clamp shown in FIG. 12(a);

FIG. 12(d) is a perspective view showing the clamp of FIG. 12(a) mounted on the open-top rail of FIG. 12(a);

FIG. 13 is an exploded perspective view of a two-part upper clamp portion, having a spring washer;

FIG. 14 is a perspective view of clamp according to the invention, installed on an inside-clicking rail with two opposing module frames;

FIG. 15(a) is an end elevation showing engagement of the clamp of FIG. 14 with the rail of FIG. 14, as well as a module frame;

FIG. 15(b) is an exploded perspective view of the clamp and rail of FIG. 14 (no module frame);

FIG. 16 is a perspective view of the clamp and plate of FIG. 8, installed on a rail;

FIG. 17 is an end view of the clamp, plate and rail of FIG. 16;

FIG. 18 is an elevation view of the clamp, plate and rail of FIG. 16, including a first module frame installed therein;

FIG. 19 is a sequence of three elevations showing installation of module frames in the clamp, plate and rail of FIG. 16;

FIG. 20 is a perspective view of the clamp and plate of FIG. 9, installed on a rail with two module frames;

FIG. 21 is the arrangement of FIG. 20, viewed in elevation from an open end of the rail;

FIG. 22(a) is an elevation end view of the clamp, plate and rail of FIG. 20, excluding the module frame;

FIG. 22(b) is a side view of the arrangement of FIG. 22(a);

FIG. 22(c) is an opposite end view of the arrangement of FIG. 22(a);

FIG. 23(a) is a perspective view of the clamp, plate and rail of FIG. 20, excluding module frames;

FIG. 23(b) is an exploded view of the arrangement of FIG. 23(a);

FIG. 24 is an exploded view of another embodiment of the invention, used with an open top rail;

FIG. 25(a) is an end view of the clamp and rail of FIG. 24;

FIG. 25(b) is a perspective view showing the clamp of FIG. 24, installed and partially installed in the rail;

FIG. 26 is a sequence of three elevations showing installation of module frames in the clamp of FIG. 24;

FIG. 27 is a perspective view of an exemplary array on a mounting surface;

FIG. 28 is a close up view of the array of FIG. 27;

FIG. 29(a) is a perspective view of another embodiment of a mid-clamp according to the present invention, including an alternative form of friction plate, installed on a rail;

FIG. 29(b) is an end view of the clamp and rail of FIG. 29(a);

FIG. 29(c) is an opposite end view of the clamp and rail of FIG. 29(b);

FIG. 29(d) is an elevation view of the clamp, plate and rail of FIG. 29(a), including a first module frame installed therein, and a second module frame partially installed therein;

FIG. 29(e) is an elevation view of the clamp, plate and rail of FIG. 29(a), including a first module frame and second module frame installed therein;

FIG. 29(f) is a perspective view of the friction plate of FIGS. 29(a)-(e);

FIG. 30(a) is a perspective view of another embodiment of a mid-clamp according to the present invention, including an alternative form of friction plate, installed on a rail;

FIG. 30(b) is an end view of the clamp and rail of FIG. 30(a);

FIG. 30(c) is an elevation view of the clamp, plate and rail of FIG. 30(a), including a first module frame installed therein, and a second module frame partially installed therein;

FIG. 30(d) is a perspective view of the friction plate of FIGS. 30(a)-(c);

FIG. 31(a) is a perspective view of another embodiment of a mid-clamp according to the present invention;

FIG. 31(b) is an elevation view of the clamp of FIG. 31(a);

FIG. 31(c) is a perspective view of the clamp of FIG. 31(a), including a first module frame installed therein, and a second module frame partially installed therein;

FIG. 31(d) is a perspective view of the clamp of FIG. 31(a), including a first module frame and second module frame installed therein;

FIGS. 32(a) and (b) are perspective views of another embodiment of a mid-clamp according to the present invention;

FIG. 32(c) is a perspective view of mounting strips which can be attached to module frames and are designed to cooperate with the clamp of FIG. 32(a) or (b);

FIG. 32(d) is a perspective view of the clamp of FIG. 32(a) or (b) secured to a rail, a first module frame with mounting strip of FIG. 32(c) attached thereto, and the first module frame with mounting strip installed in the clamp;

FIG. 32(e) is a perspective view of the clamp of FIG. 32(a) or (b) secured to a rail, a first module frame and a second module frame with mounting strips of FIG. 32(c) attached thereto, and the first module frame and the second module frame with mounting strips installed in the clamp;

FIG. 33(a) is a perspective view of another embodiment of a mid-clamp according to the present invention;

FIG. 33(b) is an elevation view of the clamp of FIG. 33(a), including a first module frame installed therein, and a second module frame partially installed therein;

FIG. 33(c) is an elevation view of the clamp of FIG. 33(a), including a first module frame and second module frame installed therein; and

FIG. 33(d) is an exploded perspective view of the clamp of FIG. 33(a).

### DESCRIPTION OF THE INVENTION

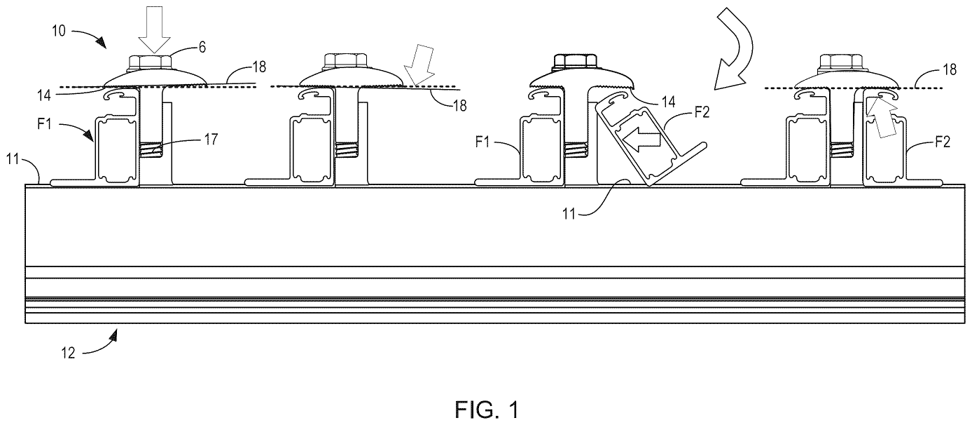

Referring to FIG. 1, a schematic illustration of the operation of the present invention is shown. Particularly, a clamp 10 is secured to a rail 12 by any one of various means known in the art. A module frame F1 is located between the clamp 10 and the rail 12. For clarity in this illustration, the solar panels associated with the module frames F are not shown. Viewing the operation from left to right in FIG. 1, a module frame F1 of a first solar panel is laid across the rail 12. The module frame F1 is positioned between a bottom surface 14 of the clamp 10 and a top surface 11 of the rail 12. A bolt head 6 is shown above the top surface of the clamp 10. Before the bolt head is tightened, a plane 18 in which the bottom surface 14 of the clamp 10 lies is slightly inclined with respect to horizontal.

The bolt head 6 is then engaged by an installer with the tool to tighten the bolt, thus compressing the module frame F1 between the bottom surface 14 of the clamp 10 and the top surface 11 of the rail 12. The bolt head 6 and its associated threaded shank 17, is preferably tightened to between 50-200 in-lb torque. Moving from left to right to the second phase of operation illustrated in FIG. 1, after the bolt head 6 is tightened, the plane 18 is now slightly declined with respect to horizontal.

Moving now from left to right to the third phase of operation illustrated in FIG. 1, a second module frame F2 is positioned between the clamp 10 and the rail 12 on an opposite side of the clamp from the first module frame F1. The frame F2 is tilted at an angle in response to the installer placing frame F2 on the rail and holding the frame on the opposite side of the module at an angle above the rail. This allows the frame F2 to fit between the bottom surface 14 and the top surface 11 of the rail 12. Particularly, the second module frame F2 is rocked in until, turning to the fourth phase, the second module frame F2 is squarely between the bottom surface 14 of the clamp 10 and the top surface 11 of the rail 12. After this rocking in of the second module frame F2, it can be seen that the bottom surface 14 of the clamp 10 is leveled out, i.e., plane 18 is substantially parallel to and coincident with horizontal. At this point, no further tightening of the bolt head 6 is required.

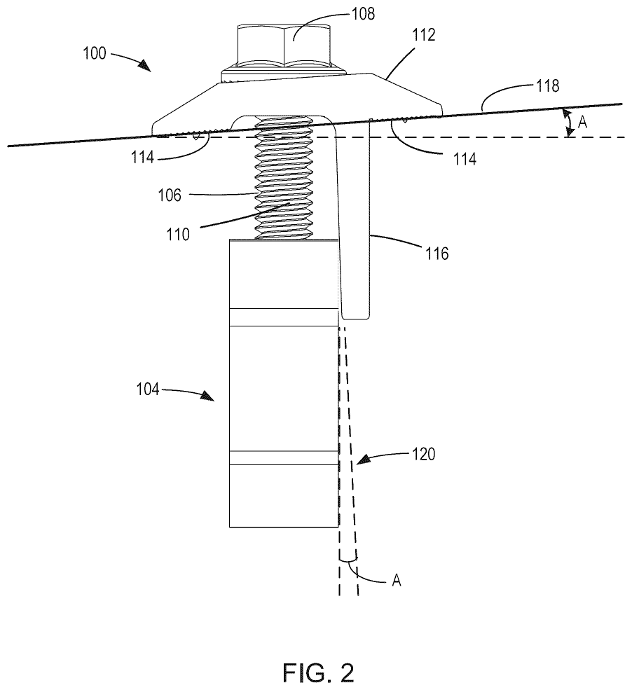

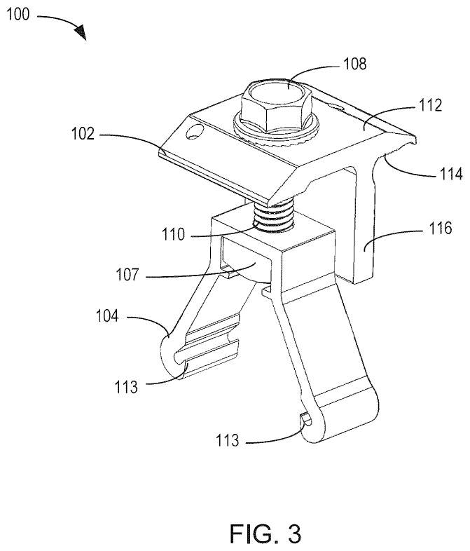

Referring now to FIGS. 2-3, a first embodiment of a mid-clamp, according to the present invention, for use with an outside clicking rail, is shown. Clamp 100 has an upper clamp portion 102 and a lower clamp portion 104. A fastener 106 having a head 108 and a shank 110 connects the upper clamp portion 102 and the lower clamp portion 104 via threaded nut 107. The upper clamp portion 102 has a top surface 112 and a bottom surface 114. A leg 116 extends downward from the bottom surface 114. Bonding pins 118 are positioned on the bottom surface 114, as is known in the art, to make electrical connection between the solar panel module frame and the mounting structure, for grounding purposes. The lower clamp portion 104 is configured such as with hooks 113 to securely, and with a bonded grounding connection, attach to a rail, such as the ClickFit® rail marketed by Esdec BV of Deventer, NL, as is well known in the art.

Upper clamp portion 102 is configured with respect to the bolt head 108 and shank 110 so that the leg 116 has a designed-in tipping. Therefore, the leg 116 is slightly angled with respect to vertical, as illustrated by the angle lines 120. Likewise, the bottom surface 114 is angled as shown by the angle A, so that a plane in which the bottom surface 114 lies is slightly angled with respect to horizontal. A suitable value for angle A will be in the range of 0.25°-7°. The angle can be imparted by creating an extrusion die accordingly, by machining, or by casting or molding the upper clamp portion 102. As shown in FIG. 2, in the clamp 100, both bottom surfaces 114 on either side of the clamp are coplanar and the bottom surface 114 adjacent, that is to say, on the same side of the clamp as the leg 116 forms an obtuse angle with the leg 116.

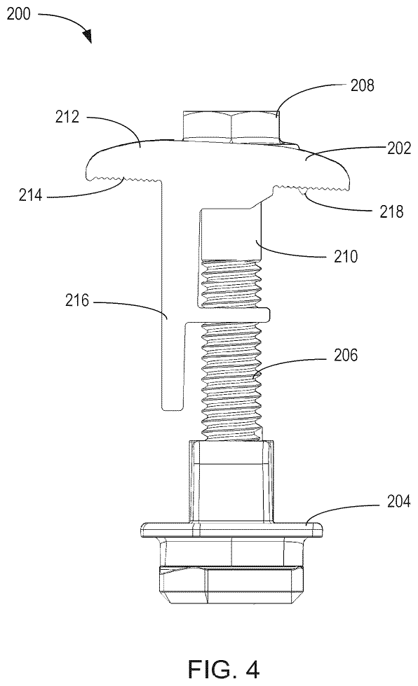

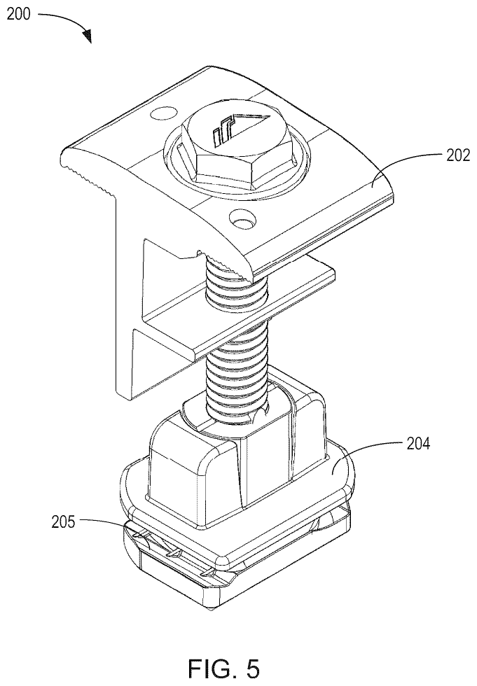

Referring now to FIGS. 4 and 5, a second embodiment of a mid-clamp 200 is shown. The clamp 200 has an upper clamp portion 202 and a lower clamp portion 204. A fastener 206 having a head 208 and a shank 210 connects the upper clamp portion 202 with the lower clamp portion 204. It will be noted that the lower clamp portion 204 has a different shape than lower clamp portion 104. This is to accommodate a different rail configuration, whereby the lower clamp portion 204 meets with a mating portion of the rail, to secure the mid-clamp 200 therein. An example open-top rail would be the Aire® rail marketed by Ironridge, Inc. of Hayward, CA, such rail being well known in the art. The bottom clamp portion 204 has a catch 205, which engages with flanges inside the open-top rail to secure the mid-clamp 200 to the rail. As can be seen in FIG. 4, the upper clamp portion 202 has a bottom surface 214 and a top surface 212, with a leg 216. The leg 216 is slightly deviated from straight vertical and the bottom surface 214 is angled slightly with respect to horizontal, as described in connection with the first embodiment of the clamp 100, above. Also similar to the clamp 100 the two opposing bottom surfaces 214 are coplanar and the bottom surface 214 adjacent to the leg 216 forms an obtuse angle with the downwardly extending leg 216. This is the side configured to receive the second frame F2 which is rotated or rocked into the clamp 200.

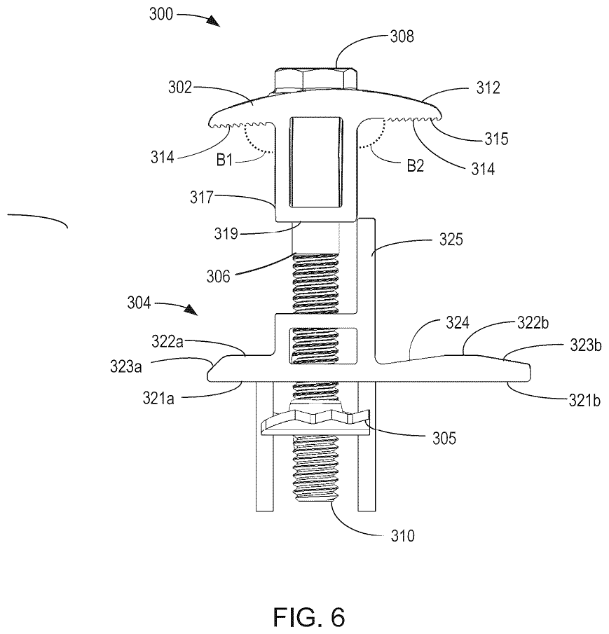

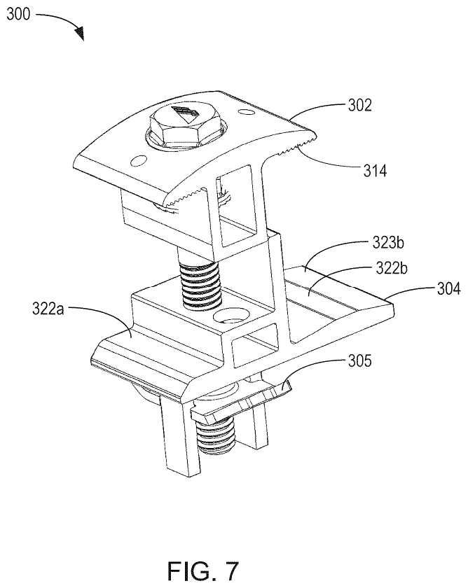

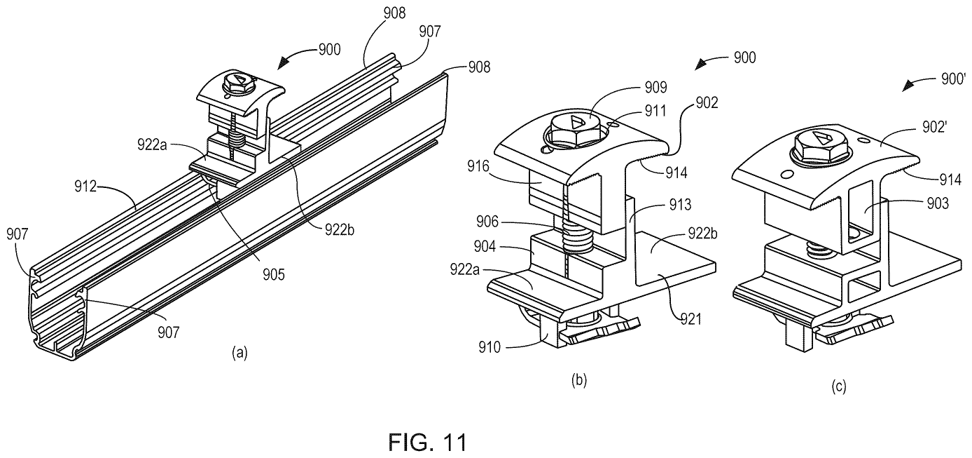

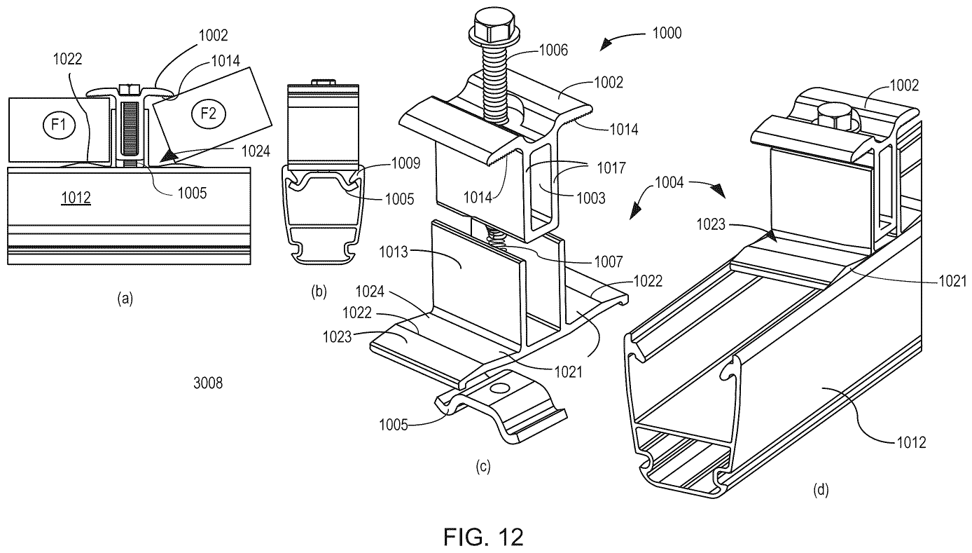

Turning to FIGS. 6 and 7, a third embodiment of a mid-clamp 300 is shown. The mid-clamp 300 has an upper portion 302, a lower portion 304 with a bolt 306 having a head 308 and a shank 310 connecting the upper portion 302 to the lower portion 304. A catch 305 is positioned on the lower portion 304 to engage with flanges in an open-top rail, such as an Aire® rail (an open channel rail shown in several of the figures herein, e.g., FIG. 11(a)) securing the clamp in the rail as is known in the art and as generally described in connection with the embodiment above. As shown in FIG. 6, the upper portion 302 has a top surface 312 and a bottom surface 314. The bottom surface 314 has serrations 315 for engaging with module frames. The upper clamp portion 302 has two sidewalls 317 and a bottom wall 319, which together with bottom surface 314 define a hollow through which the bolt shank 310 passes. The bottom surface 314 is tilted with respect to horizontal, so that a plane encompassing the bottom surface 314 forms an acute angle with a horizontal plane, as described in embodiments above. Lower clamp portion 304 has two ledges 321. Ledge 321a is on a first side of clamp 300 configured to receive the first solar module frame F¹ and 321b is on a second side of clamp 300 configured to receive the second module frame F². On each ledge 321, a bottom surface of a mating module frame F (not shown here) would rest in the manner illustrated in FIG. 1. A top surface 322a of ledge 321a is coplanar with a top surface of a raised portion 322b of ledge 321b, as can be seen in FIG. 7. Ledge 321b is contoured to facilitate rocking-in of a module frame for securement between bottom surface 314 and top surface 322b. Particularly, a rock-in pocket 324 may be defined between a vertical flange 325 on the lower clamp portion 304 and raised portion 322b on flange 321b. The rock-in pocket 324 receives the lower near edge of a second module frame F² and provides clearance for the edge to rock-in and secure the module frame between the upper clamp portion 302 and the rail, or the ledge 321, as generally shown in FIG. 1 and in FIG. 12(a). The bottom surface 314 on the first side of clamp 300 is above the ledge 321a and clamps the module frame F¹ directly on raised surface 322a. This first bottom surface 314 forms an acute angle with its adjacent sidewall 317. The bottom surface 314 on the second side of clamp 300 is above the ledge 321b and clamps the module frame F² directly on raised surface 322b. This second bottom surface 314 is not coplanar with the first bottom surface 314 and is substantially orthogonal to its adjacent sidewall 317.

The ledges 321 comprise ramped distal ends or guides 323 that act to facilitate movement between the module frames F and the ledges 321. Guide 323a is ramped to facilitate the sliding of the ledge 321a under the bottom of the frame F¹ when it is sitting on the rail 912. Guide 323b is ramped to facilitate the movement of the frame F² up onto the raised portion 322b as it moves across the rail 912 top surface 908.

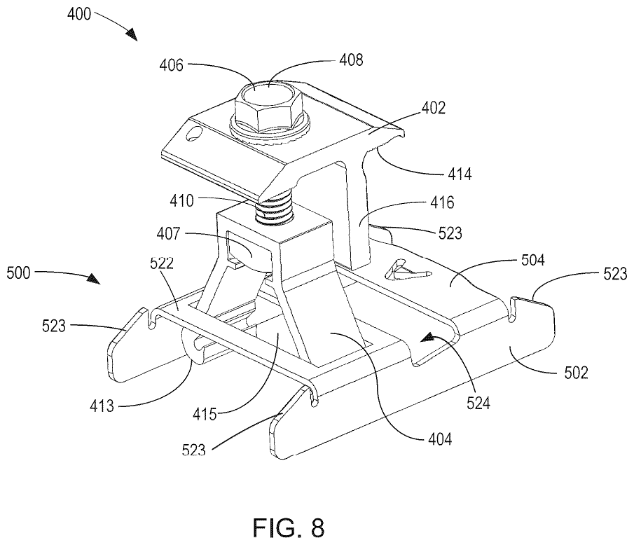

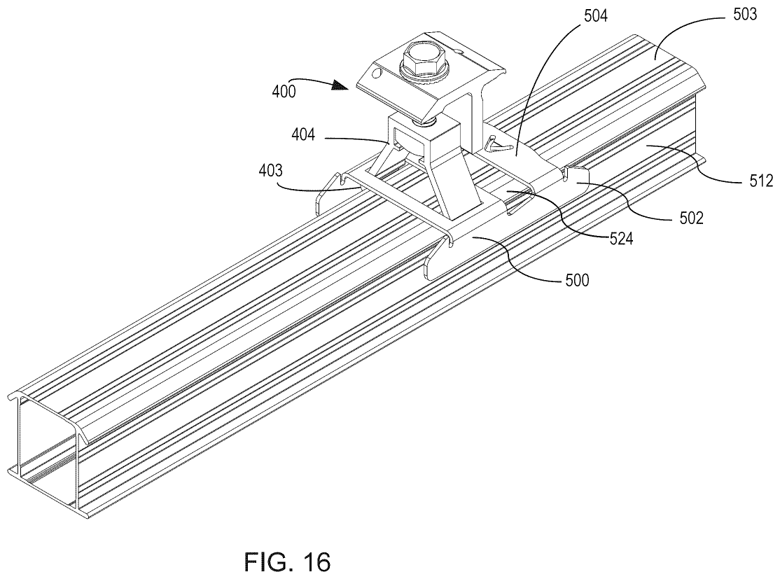

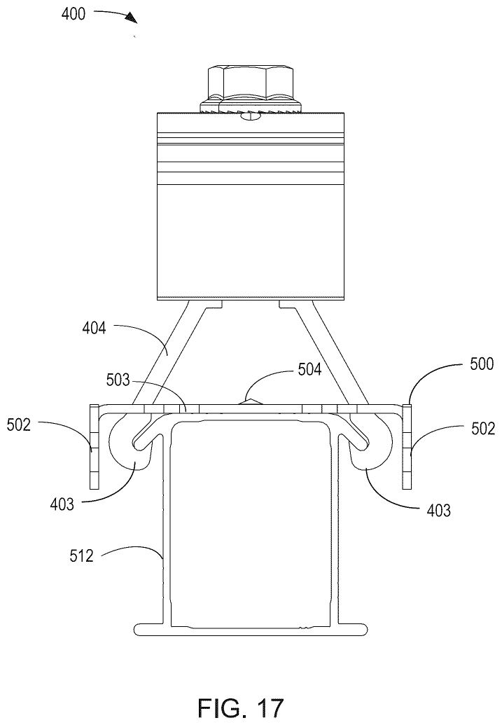

Referring now to FIG. 8, a fourth embodiment of a mid-clamp 400 is shown. The mid-clamp 400 is configured to cooperate with outside clicking rails like ClickFit® and is similar to clamp 100 shown in FIGS. 2 and 3. The mid-clamp 400 has an upper clamp portion 402 and a lower clamp portion 404, with a bolt 406 having a head 408 and a shank 410 connecting the two portions. An upper section of the lower clamp portion 404 houses a captive nut 407 which receives the threaded bolt 406. The lower clamp portion 404 has a general shape which resembles a tapered form which is narrower at the top and wider at the bottom. Hooks 413 at the lower ends of the lower clamp portion 404 engage with a rail that is suitably designed to receive and secure the hooks 413, such as the ClickFit® rail mentioned above. This engagement is seen in FIGS. 16 and 17. Upper clamp portion 402 has a bottom surface 414, top surface 412, and a leg 416.

Referring again to FIG. 8, the mid-clamp 400 is paired with a plate 500. The plate 500 has runners 502 and a cross member 504. The plate 500 is preferably made from a durable, yet light metal. Cross member 504 cooperates with lower clamp portion 404 to form a rock-in pocket 524. Particularly, when a second module frame is installed on a side of leg 416 and under bottom surface 414, a bottom surface of the module frame rests on the cross member 504, and this metal or other material from which cross member 504 is made is low friction, such as by anodizing. Surface of cross member 504 is compatible with anodized solar module frames to provide minimal friction between these interacting surfaces. Mill finish or unfinished aluminum alloys commonly used to make extruded aluminum rails can be softer than the relatively harder module frames which can be made of steel or anodized aluminum among other materials. The friction plate 500 may be made of stamped steel providing a low friction surface for the module frame to slide across or rotate across until the bottom corner passes the edge of the cross member 504 and enters the rock-in pocket 524. The rock-in pocket relieves pressure facilitating the module rocking into place in the horizontal installed orientation. Bearing in mind that a first, opposing module frame will have already been installed on a side of mid-clamp 400 opposite leg 416, and the bolt 406 already tightened to desired torque (50-200 in-lb), the rocking-in motion in which the second module frame is moved will cause a bottom surface of the module frame to slide on cross member 504 and into pocket 524, thereby providing clearance for the module frame to be rocked into place and clamped between the bottom surface 414 and the cross member 504. For this purpose, the plate 500 rests on a top surface 503 of a supporting rail 512, as shown in FIGS. 16 through 19. A window 415 in the plate 500 receives the lower clamp portion 404 to provide clearance for the hooks 413 to engage the rail. The runners 502 flank the rail. Runners 502 include ramped ends that act as guides facilitating the module frame movement onto the cross member 504 and the top surface 522.

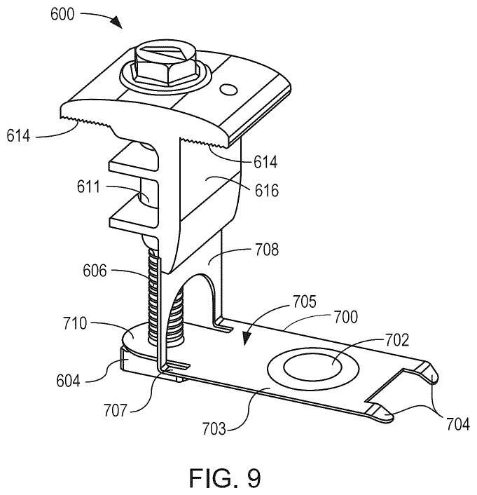

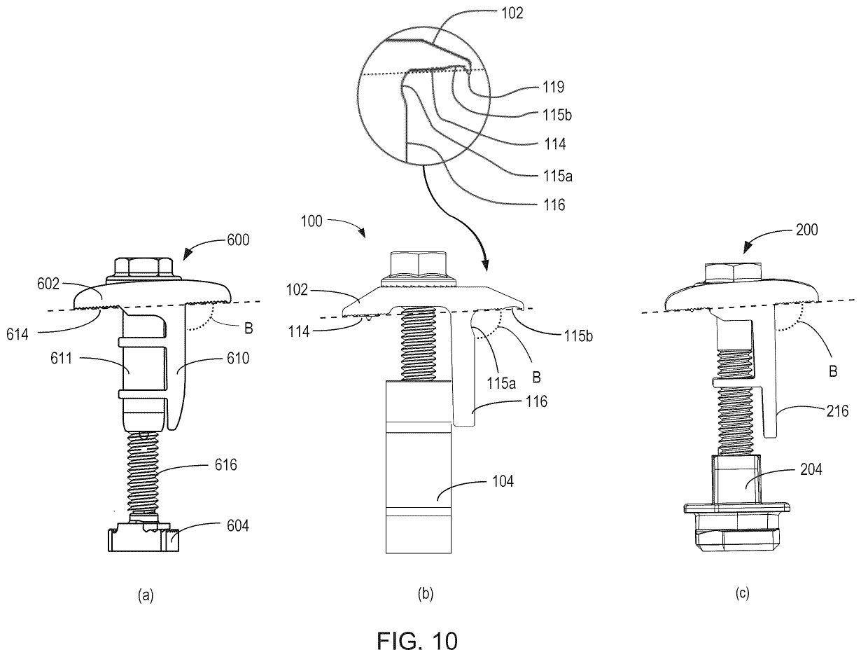

Referring to FIGS. 9 and 10(a), a further embodiment of a mid-clamp 600 is shown. The clamp 600 is suitable for use in rails, such as the XR Rail® marketed by Ironridge, Inc. and well-known in the art, or the SolarMount® rail system marketed by Unirac, Inc. of Albuquerque, NM. Clamp 600 has a top portion 602 and a bottom portion 604. Bottom portion 604 engages with a slot in the top of the rail, in a manner already known and as will be apparent to those skilled in the art. Bolt 606 connects the two portions. Top portion 602 has a bottom surface 614 and a leg 616. Hull 611 contains bolt 606 and gives strength to top portion 602.

A friction plate 700 may take the form of a bent piece of sheet metal having a raised section 702. Here, the section 702 is dome shaped and rises slightly above the top surface 703 of the plate 700. Standoffs 704 are ramped guides located at a distal end of the plate 700 and act to facilitate the movement of frame F² onto the plate 700. Plate 700 is cut and bent at joint 707 to form a vertical portion 708 which engages leg 610. Flat 710 has an opening through which the bolt 606 passes. Flat 710 may extend outward from bolt 606 over the rail 2000 so as to support the module frame when clamped between the top clamp portion 602 and the rail 2000. Flat 710 is positioned above bottom portion 604 of the mid-clamp 600. Raised section 702 forms a rock-in pocket 705 adjacent thereto, giving clearance to install the module into the mid-clamp 600 adjacent leg 610 after the mid-clamp 600 has been tightened to the appropriate torque as described in embodiments above. The standoffs 704 rest on either side of a top surface of the rail to prevent the plate 700 from rotating about bolt 606.

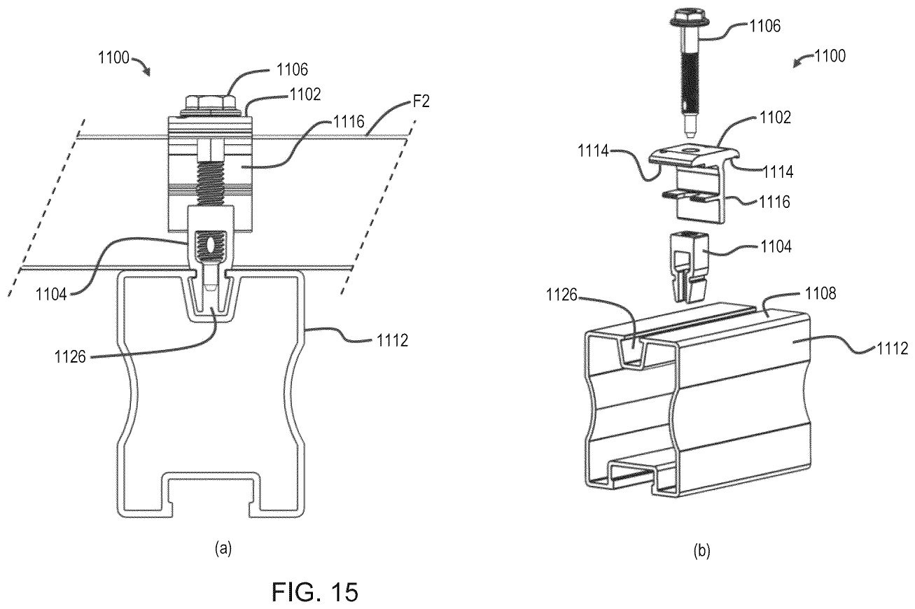

Referring to FIGS. 10(a)-(c), and for purposes of comparing and contrasting, embodiments of the mid-clamps 600, 100, 200 according to the present invention, respectively, are shown in elevation views. Each clamp embodiment shown in FIGS. 10a, 10b and 10c have a specific lower clamp portion configured to cooperate with a different rail type. The clamp of FIG. 10a cooperates with a rail with a top slot. The clamp of 10b cooperates with an outside clicking rail. The clamp of 10c cooperates with an open top rail. Additionally the clamp of FIG. 15 cooperates with an inside clicking rail. With particular reference to FIG. 10(b), upper clamp portion 102 may include cutouts 115, at the distal end of bottom surface 114, and at the joint between bottom surface 114 and leg 116 provide added clearance for the upper corners of the module frame and aid in inserting and rocking it into the space between upper clamp portion 102 and the rail to which lower clamp portion 104 has been attached. Cut out 115a may be located in the vertical leg 116 near the bottom surface 114. Cut out 115b may be located in the bottom surface 114 near the distal end and be terminated by a downwardly extending tip 119 that may extend beyond the bottom surface 114 as shown. It is understood that any clamp embodiment upper portions included herein may include one or both of the cut outs 115.

The clamps of the current invention are commonly known as mid-clamps and as is well known in the art, mid clamps fit between modules and serve to clamp two module frames. This is achieved by two opposing and outwardly extending flanges on either side of the upper clamp portion. Each flange has a bottom surface 114, 214, 608. In the clamps shown in FIGS. 10a to 10c, the bottom surfaces 14, 114, 214, 314, 414, 614, 914 of the opposing flanges are coplanar. This bottom surface plane forms an obtuse angle B with the leg 116, 216, 610 on the side where the second module is rocked into the clamp.

Referring to FIG. 11(a), an open-top rail 912 has received in it a clamp 900. Referring to FIG. 11(b), clamp 900 has an upper clamp portion 902 and a lower clamp portion 904 with bolt 906 therebetween. Catch 905 engages flanges 907 in open-top rail 912 to secure the clamp in the rail. Ledges 921 rest on flanges 907 and inside the open top of the rail, with a top surface of ledges 922a, 922b at or just above a height of upper edges 908 on the rail 912. Ledges 921 span the width of the open top of the rail 912 between upper edges 908 so that clamp 900 rests in stable fashion in the rail. Stops 910 hold catch 905 against rotation so that when bolt 906 is tightened, catch 905 rides up and fully engages undersides of flanges 907. A bottom surface 914 of upper clamp portion 902 is inclined as described in connection with the embodiments above. Bolt head 909 may rest in a counterbore 911. Lower clamp portion 904 has an upward leg 913 which engages with slight clearance and moves relative to downward leg 916 on upper clamp portion 902. In operation, a first module is laid on rail 912. Clamp 900 is then placed and butted up to the module frame so that the frame touches or nearly touches leg 915. Bolt 906 is then tightened to the prescribed torque. This secures the first module to the rail by clamping the frame between the bottom surface 903 and the top surface 922a. A second module is then placed on the rail at a tilted angle such that one side of the module is on the rail and the opposite side of the module is held above the rail. The bottom edge of the lower frame is then placed on the ledge surface 922b at the tilted angle and then rocked into the space between bottom surface 903 and ledge surface 922b, adjacent upward leg 913. In this embodiment the space above the upward leg 913 can act as a cut out or rock-in pocket similar to the leg cut out 115 shown in FIG. 10(b) providing space to facilitate the rocking in to the final installed position. Further tightening of bolt 906 is not then required due to the inclined bottom surface 914 and its cooperation with ledge surface 922b on rail 912. The distance between bottom surface 914 and upper edges 908, or surface 922b, is slightly less than the thickness of the module frame F², thus providing the necessary clamping force on the second module without the need for the installers to reach over the first module and tighten the bolt 906. Surface 922b may be above edges 908, as shown in FIG. 11(a), so that the module frame engages surface 922b on insertion, instead of the more friction-prone edges 908 of the rail 912. Surface 922a may also be above edges 908 supporting the module frames of adjacent modules at the same height above the rail 912. It is understood that the clamp 900 is similar to the exemplary clamp 10 with the exception that clamp 900 includes the lower portion 904 with ledges 921 that rise above the edges 908 providing friction reduced surfaces to facilitate the rocking in of the second modules and subsequent modules across the mounting surface.

Referring to FIG. 11(c), another embodiment of the mid-clamp 900′ is shown. It is similar in most respects, regarding construction and operation, to mid-clamp 900, except it has walls forming a hollow 903 in its upper clamp portion 902′. This simply provides for more spacing between adjacent, installed modules as compared to mid-clamp 900, as will be appreciated by those skilled in the art from the instant description and drawings.

Referring to FIGS. 12(a)-(d), another embodiment of a mid-clamp 1000 is shown. The mid-clamp 1000 engages with an open-top rail 1012. Clamp 1000 has an upper portion 1002 and a lower clamp portion 1004, and fastener 1006. Lower clamp portion 1004 is configured with a catch 1005 and a spring 1007. Ledges 1021 have ramped guides 1023 to facilitate module frames moving onto the ledges 1021 and the raised portions 1022. The raised portions 1022 which lack the flat top present in other embodiments thus create raised ridges 1022 which create rock-in pockets 1024 and provide a contact surface for the module frames that is of lower friction than rail 1012, to facilitate rocking-in of a module frame during insertion to the mid-clamp 1000 as shown in FIG. 12(a). The ridges 1022 extend above a top edge of the rail 1012, as shown in FIG. 12(a). An upper clamp portion 1002 is biased upward by the spring 1007 for ease of installing the clamp 1000 on a first module frame F¹. Referring to FIG. 12(a), when a second module frame F² is rocked in on an opposite side of the lower clamp portion 1004, ridges 1022 engage a bottom of the frame and provide low friction and the rock-in pockets 1023 create clearance for inserting the frame. The frame is then rotated downward, or rocked, so that its top engages a bottom surface 1014 on upper portion 1002, and its bottom surface rests on ridge 1022. For securing the clamp 1000 to rail 1012, catch 1005 engages flanges 1009, as shown in FIG. 12(b), being tightened up by bolt 1006.

Unlike previously described embodiments, clamp 1000 is reversible as the clamp structures are symmetrical. Either side of the clamp 1000 can receive the first frame F¹ and either side of the clamp 1000 can accept the second frame F² and the rocking-in method. As can be seen in FIG. 12a, the two bottom surfaces are not coplanar and both bottom surfaces form acute angles with their adjacent sidewalls 1017.

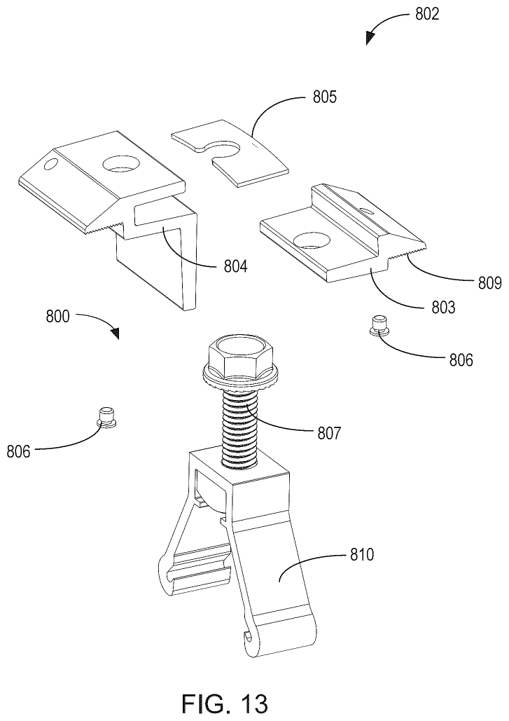

Referencing FIG. 13, mid-clamp 800 has an upper clamp portion 802 which may be provided with a male and female section, 803 and 804, respectively. A spring washer 805 is inserted in the female section 804 and is located above the male section 803 so as to give the male section 803 a spring action, when upward forces, such as from the top of a solar panel module frame, are exerted on the male section 803. Bonding pins 806 are shown. On installation, even after bolt 807 is tightened, there is clearance for male section 803 to move up and down relative to female section 804. The spring washer 805 biases male section 803 downward, but when a second module frame is inserted, the male section can deflect slightly upward for clearance to insert the frame between a bottom surface 809 of male section 803 and a rail to which the mid-clamp 800 has already been installed via bottom portion 810. The connection of bottom portion 810 to a rail is known in the art, such as with the ClickFit® rail system mentioned above. Importantly, all of the heretofore described embodiments of the invention have an upper clamp portion with a bottom surface which is, at least in part, inclined with respect to horizontal, as explicitly shown and described with angle A in FIGS. 1 and 2. However, the mid-clamp 800 may, or may not, have such an inclined surface, owing to the resilient “play” that is present with male section 803 in cooperation with spring washer 805.

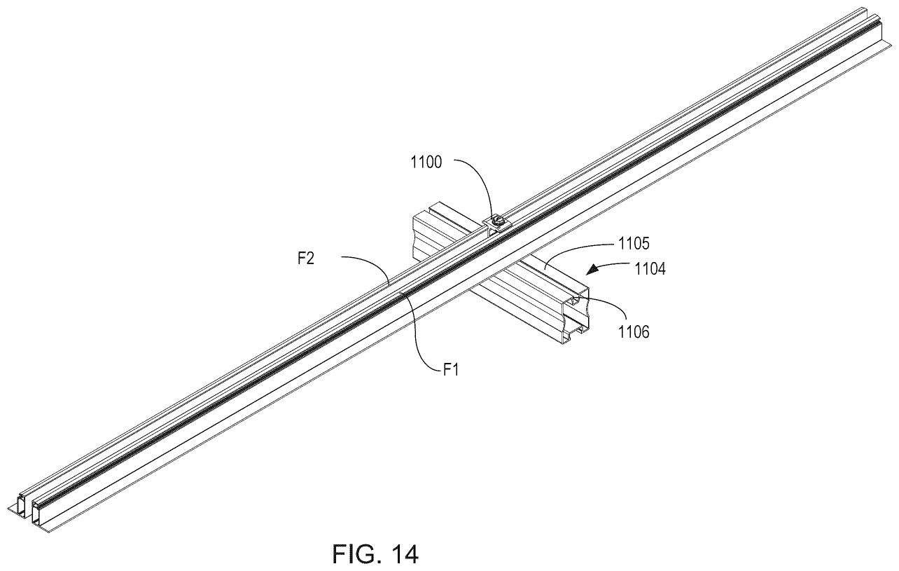

As shown in FIGS. 14 and 15, another rail type with so-called “inside clicking” may be used with the present invention. Such rails are marketed, for example, by Schletter Solar GmbH of Kirchdorf, Germany. Mid-clamp 1100 is shown between two module frames F¹, F². It is understood that the two frames shown are each one of four perimeter frame portions surrounding two separate solar panel modules. Rail 1104 has a central channel 1126 which receives a lower clamp portion 1104, which is configured to mate with the central channel 1126 in a snap-in, positive engaging manner, as shown in FIG. 15 and as will be known to those skilled in the art. The module frame F is secured between the clamp 1100 and a top surface 1108 of rail 1112. The clamp 1100 in all other respects, except for lower clamp portion 1104, is similar in construction and operation to clamp 200 or 600, described above. Alternately clamp 1100 could be used in conjunction with a friction plate similar to plate 500. Plate 500 would be modified to work with clamp 1100 and rail 1112. The plate 500 window would be sized to receive the lower portion 1104 and the plate width would be sized to fit the rail 1112.

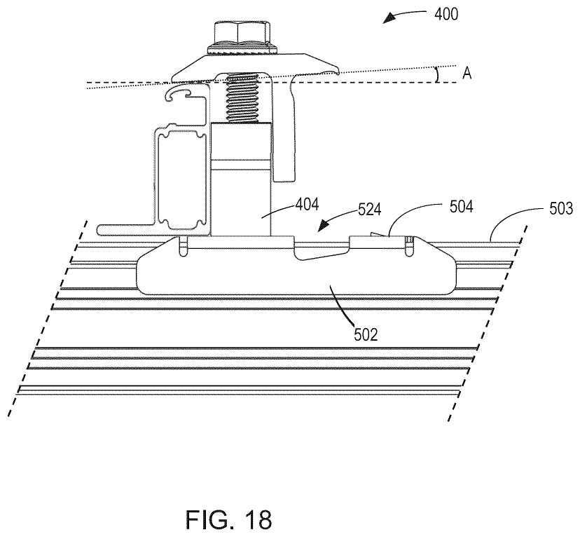

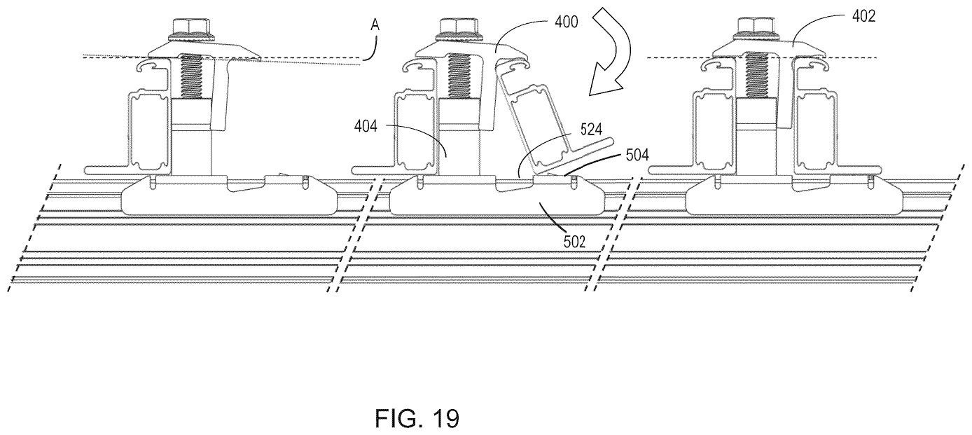

FIGS. 16-19 will now be referenced for describing the operation of mid-clamp 400, mentioned above in FIG. 8. FIG. 16 shows a ClickFit® rail, having a top surface 503. Clamp 400 engages the rail on its upper outer edges via hooks 403. Plate 500 thus then rests on rail surface 503. Runners 502 flank the upper outer edges of the rail, as can be seen in FIG. 17. Likewise, cross member 504 rests on surface 503. FIG. 18 shows how the window 424 on clamp 400 exposes a portion of top surface 503 between the lower clamp portion 404 and cross member 504. This defines a pocket, as will be explained with reference to FIG. 19. FIG. 19 shows insertion of a second module frame into clamp 400. Starting from left to right on FIG. 19, a first module frame F¹ is in position on the left side of clamp 400. Moving to the right in the next portion of FIG. 19, the bolt has been tightened, thus tilting the upper clamp portion as described in FIG. 1. The second module frame F², on the right side of clamp 400, is then inserted and rocked-into the space between upper clamp portion 402 and plate 500. Particularly, a lower edge of the module frame engages cross member 504, which is low-friction. That edge due to the rocking in motion moves to the left toward the lower clamp portion 404 on the surface of cross member 504. Once clear of cross member 504, the frame encounters the window 524, which further reduces friction, provides more clearance, and prevents binding or seizing of the frame within the clamp. Next, as shown on the far right, the second module has been installed and seated in the clamp 400, and a force between upper clamp portion 402 and cross member 504 holds the frame in place. The bottom surface 414 of upper clamp portion 402 is now roughly even with horizontal as shown by the dashed line.

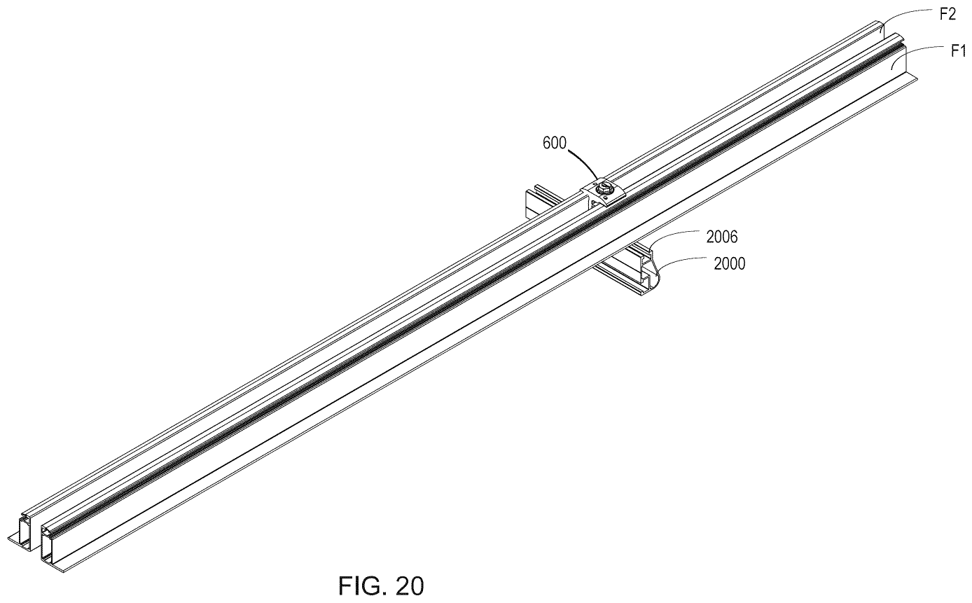

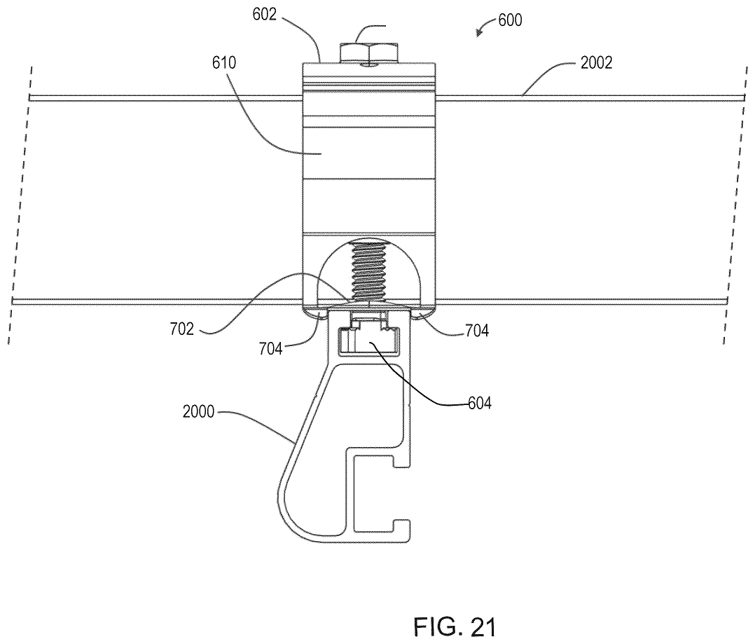

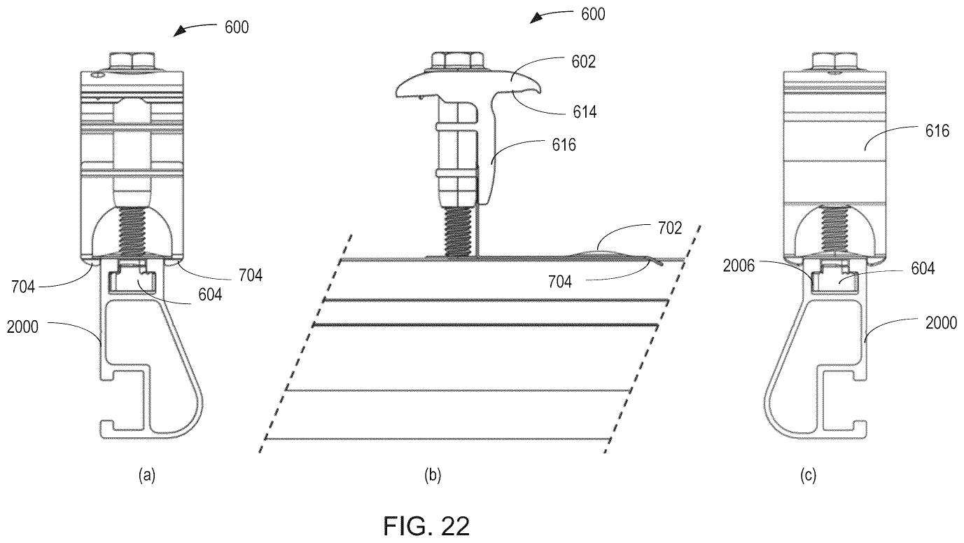

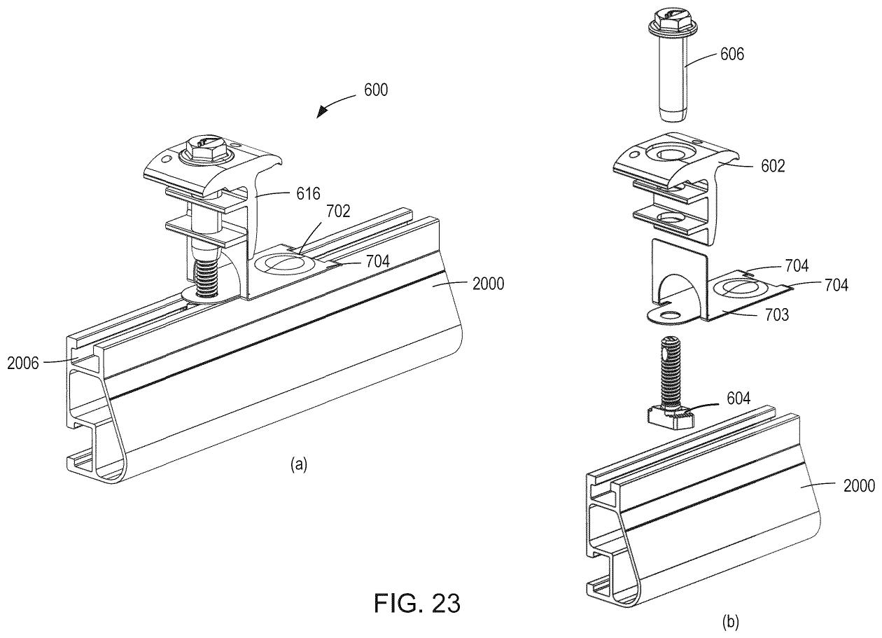

FIGS. 20-23 will now illustrate operation of mid-clamp 600, mentioned above in FIG. 9. The XR® rail 2000 is shown in FIG. 20. Module frames F¹ and F² are here shown installed, back to back on either side of mid-clamp 600. Lower clamp portion 604 is engaged in slot 2006 in the rail 2000, as is known in the art. Friction plate 700 rests under the module frames F and on top of the rail 2000. Raised portion 702 of plate 700 is positioned to the right of clamp leg 610, and standoffs 704 flank the outside upper edges of rail 2000, on either side of slot 2006, to hold plate 700 from rotating out of position during installation of the clamp and module frame. Friction plate 700 and raised portion 702 present a low-friction surface on which the module frame F² may land and move and rotate across during the rocking-in process. Raised portion 702 extends above the top surface of rail 2000 as shown in FIG. 22. Once installed, in a manner similar to that shown and described in FIG. 19, the module frame 2002 is secured by clamp load between upper clamp portion 602 and raised portion 702.

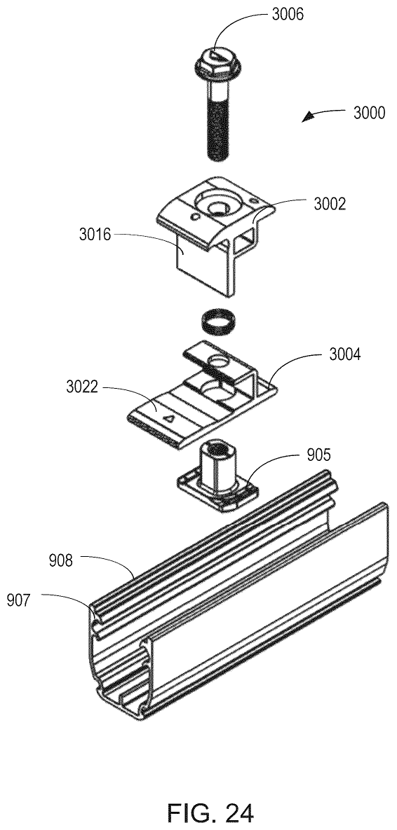

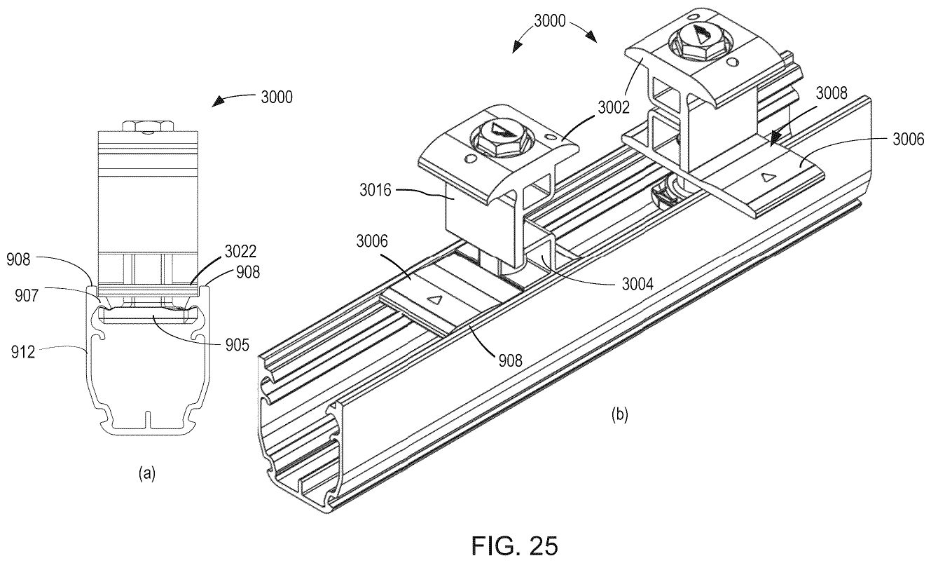

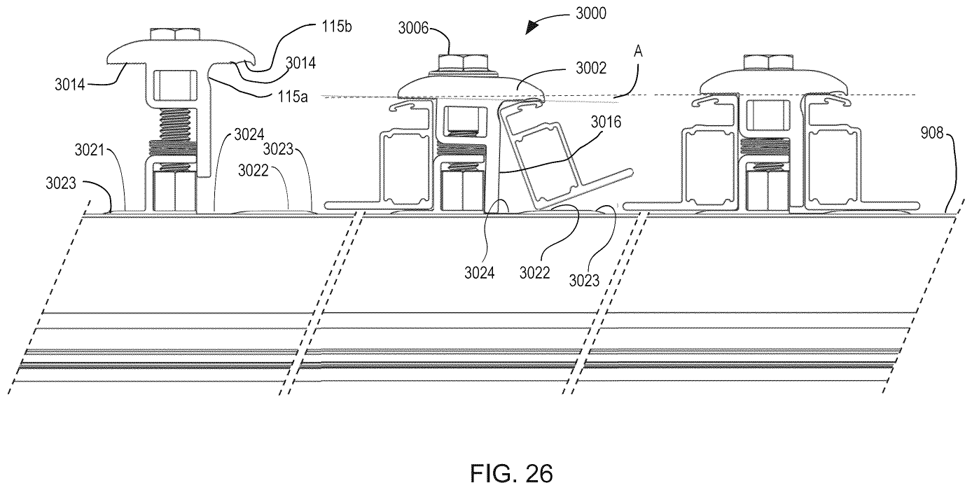

FIGS. 24-26 illustrate another embodiment a mid-clamp 3000, for use with an open top rail, such as the Aire® rail identified above. Clamp 3000 has an upper clamp portion 3002 and a lower clamp portion 3004. A catch 905 and a fastener 3006, secure the clamp in cooperation with flanges 907 located in an upper inside portion of the rail. Ledges 3021 on lower clamp portion 3004 include raised portions 3022 which are raised above upper edges 908 on the rail and define pocket 3024 between raised portion 3022 and leg 3016 of upper clamp portion 3002. Referring to FIG. 26, after a first module frame F¹ is secured on the left side of clamp 3000, the bolt is tightened (as described above) and upper clamp portion 3002 tilts slightly so that its bottom surface 3014 plunges just below horizontal, as shown by the dashed line and represented by angle A between relative horizontal or parallel to the top surface 908 of the rail 912 and the plane of the bottom surface 3014. A second module frame F² is then inserted and rocked-in between the bottom surface 3014 of the down-tilting upper clamp portion 3002 and ledge 3021. The frame's bottom left corner rides on the low-friction surface of raised portion 3022 of ledge 3021 until it reaches pocket 3024. At which time more clearance and even less friction is encountered by the frame, resulting in proper seating of the frame in the clamp and a tactile easing of the frame into the installed orientation. As seen on the far right of FIG. 26, the second module frame F² is clamped between the bottom surface 3014 of the upper clamp portion 3002 and ledge 3021, and the upper clamp portion has returned to horizontal or near-horizontal position as shown by the dashed line.

As will be appreciated from the above description, the mid-clamp, according to the present invention, allows a single installer to install a module by providing that the edge of a second module may be clamped without the installer having to reach over the first module. The clamp has an angled clamping surface relative to the normal direction of the solar panel module frame surface. The clamp is stable enough so that it can be clamped onto one module, the bonding pins helping to facilitate gripping and clamping action. The clamp is designed to tip slightly as the clamp is tightened so the gap between the open clamp lip and rail is slightly less than the thickness of the module. When the module is inserted into place, this stresses the clamp and produces a clamp load. For the mid-clamp 800, in FIG. 13, the spring washer 805 may provide enough clamp force for the second module, so that the inclined surface on the bottom of the upper clamp portion is not required.

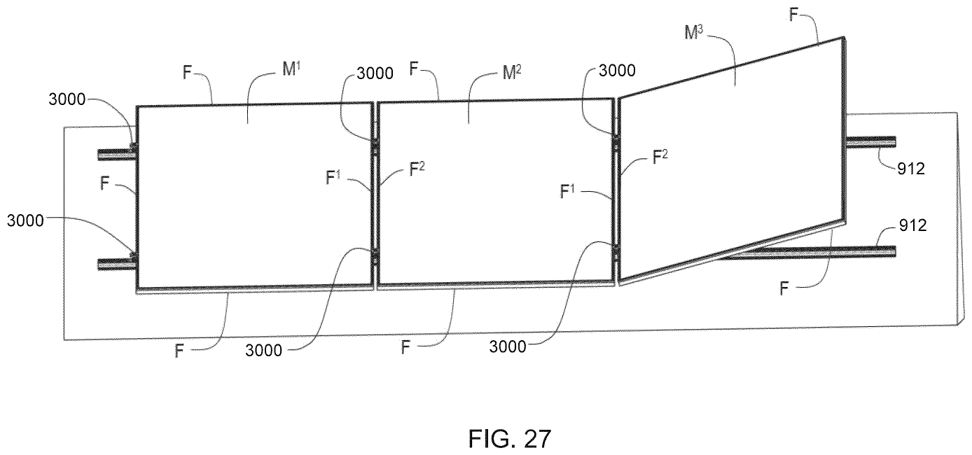

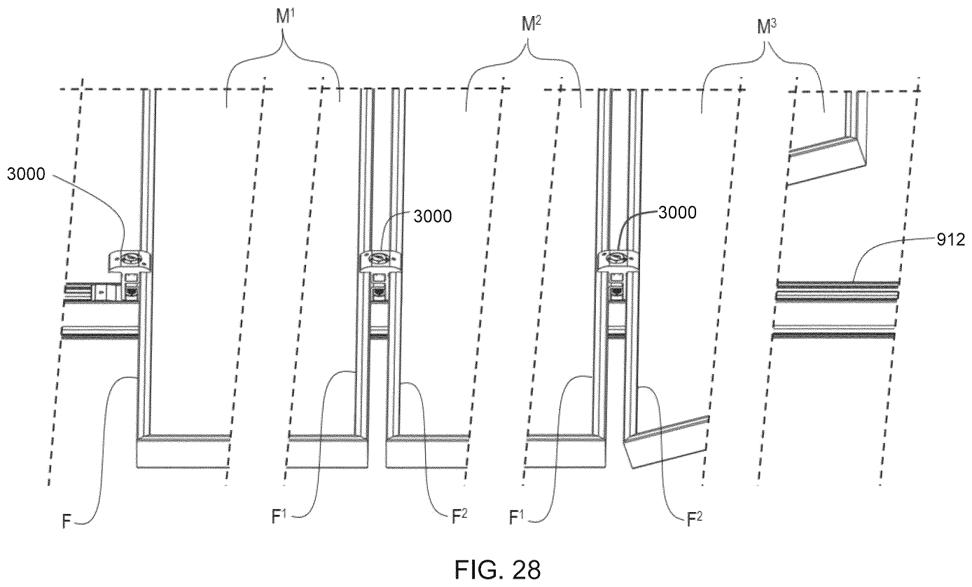

Turning now to FIGS. 27 and 28 we see a simple array of 3 modules M¹, M² and M³ during installation on 2 rails attached to a mounting surface such as a roof. FIGS. 27 and 28 is illustrated using the clamps 3000 and the rail 912 as an example. The illustration could have been shown using any appropriate clamp and rail combination. FIG. 27 is a perspective view showing the whole array. FIG. 28 is a close up of the same view showing more detailed view of the front rows of clamps and rail. The first module on the left M¹ is fully installed and secured to the rails 912 by four clamps 3000. Clamp 3000 like the other clamp embodiments herein can be used as an end clamp. In this way they are universal end and mid clamps. For this system other end clamps such as hidden end clamps may also be used. To use the clamp 3000 as an end clamp, it is necessary to reverse the orientation of the clamp so that the leg 3016 is away from the module frame and the module frame is secured in what is heretofore considered the first side of the clamp.

The second module M² is also fully installed, secured and clamped onto the rails 912 by the clamps 3000 all four of which are being used as mid-clamps as there are module frames on both sides of the clamps 3000. The third module is in the process of being installed. It is tilted or held at an angle to the rails with the left frame F² placed on the rail or in this case the ledge 3021 and is about to be rotated down in the rocking-in process as the raised frame is lowered down to the rails 912. At that point it will be clamped down on the outside using additional clamps 3000 or an alternate end clamp option.

In FIG. 27 we see that each module M is made up of a flat plate. The flat plate is typically made of glass which houses the energy producing solar cells and is surrounded by four module Frames F. F¹ shown is the first frame that receives the mid-clamps which are typically slid along the rails until the upper clamp portion is above the frame F1 and if the embodiment includes ledges or a friction plate the ledge or friction plate is under to frame F¹. Then the fastener 3006 is tightened to the appropriate torque and the module frame F1 is thus secured to the rail. When the second module frame F² is then rocked-in to the second side to the clamp the rotation of the frame creates and upward force against the bottom surface of the upper portion of the clamp. The upper portion having been tightened appropriately resists the upward force and thus exerts a clamping force against the module frame F².

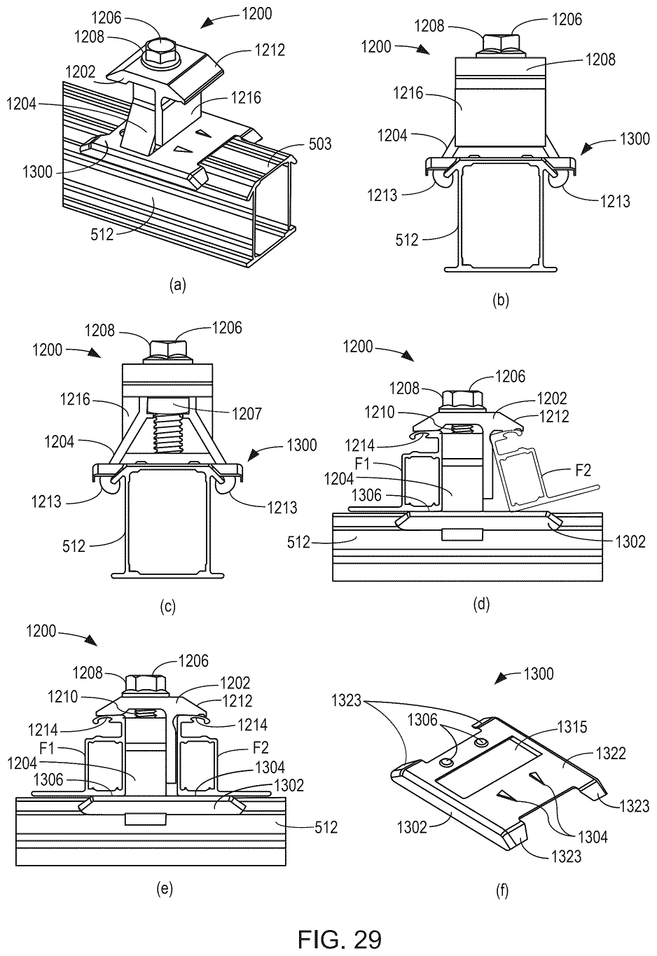

Referring now to FIGS. 29(a)-(f), another embodiment of a mid-clamp 1200 is shown installed on a rail 512. The mid-clamp 1200 is configured to cooperate with outside clicking rails like ClickFit® and is similar to clamp 100 shown in FIGS. 2 and 3. The mid-clamp 1200 has an upper portion 1202 and a lower portion 1204, with a bolt 1206 having a head 1208, a shank 1210, and a captive nut 1207 connecting the two portions. The lower clamp portion 1204 has a general shape which resembles a tapered form which is narrower at the top and wider at the bottom. Hooks 1213 at the lower ends of the lower clamp portion 1204 engage with a rail 512 that is suitably designed to receive and secure the hooks 1213, such as the ClickFit® rail mentioned above. This engagement is seen in FIGS. 29(b) and (c). The upper clamp portion 1202 has a bottom surface 1214, top surface 1212, and a leg 1216.

Referring again to FIGS. 29(a)-(f) the mid-clamp 1200 is paired with a plate 1300. The plate 1300 has runners 1302 and a window 1315 to receive the lower clamp portion 1204 to provide clearance for the hooks 1213 to engage the rail 512. The plate 1300 is preferably made from a durable, yet light metal. Ramped guides 1323 facilitate movement of module frames F1 and F2 onto the top surface 1322 of the plate 1300. The plate 1300 may be made of stamped steel providing a low friction surface for the module frame F2 to slide across or rotate across during rock-in installation as shown in FIG. 29(d) until fully clamped between the bottom surface 1214 and the top surface 1322 as shown in FIG. 29(e). For this purpose, the plate 1300 rests on a top surface 503 of the rail 512. Prior to rock-in installation of the module frame F2, the module frame F1 is installed and clamped between the bottom surface 1214 and the top surface 1322 by tightening the bolt 1206 to the desired torque (50-200 in-lb). Therefore, during rock-in installation of the module frame F2, and after rock-in installation, a clamping force will be exerted on the module frame F2 between the bottom surface 1214 and the top surface 1322. The plate 1300 includes conical-shaped raised portions 1306, which are open at the top and engage the module frame F1 to provide a ground bonding connection. The plate 1300 also includes triangle-shaped raised portions 1304, which engage the module frame F2 to provide a ground bonding connection. The raised portions 1304 are tapered, with the highest part of the raised portion being closest to the window 1315. This taper of the raised portions 1304 allows minimal resistance to the module frame F2 during rock-in installation.

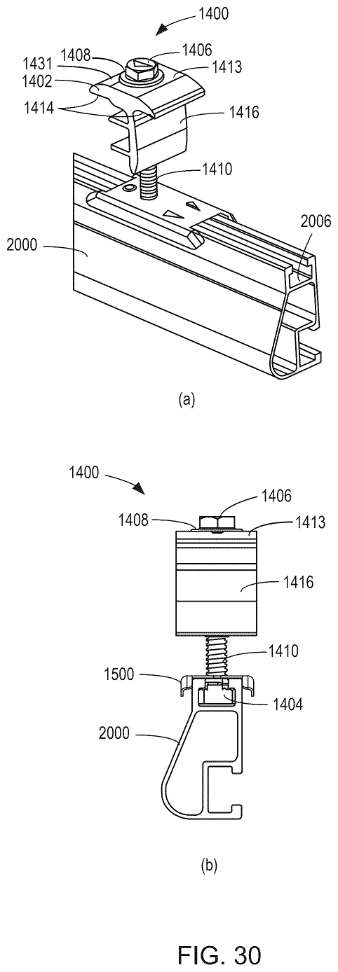

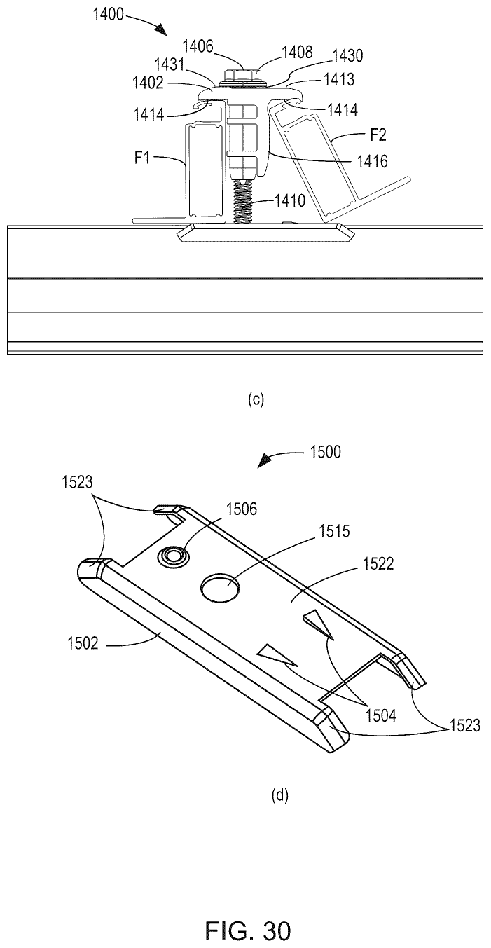

Referring now to FIGS. 30(a)-(d) another embodiment of a mid-clamp 1400 is shown installed on a rail 2000. The mid-clamp 1400 is configured to cooperate with rails having a slot 2006 like the XR Rail® or the SolarMount® rail and is similar to the clamp 600 shown in FIG. 10(a). The mid-clamp 1400 has an upper portion 1402, with a bolt 1406 having a head 1408 and a shank 1410 connecting to a lower portion 1404 that engages with the slot 2006 in the rail 2000. The upper clamp portion 1402 has a bottom surface 1414, top surface raised portion 1431, a lowered portion 1413 which forms a gap 1430 between the bolt head 1408 and lowered portion 1413, and a leg 1416. The top surface raised portion 1431, lowered portion 1413, and gap 1430 are similar features to mid-clamp 1600 and will be described in further detail below.

Referring again to FIGS. 30(a)-(d) the mid-clamp 1400 is paired with a plate 1500. The plate 1500 has a through hole 1515 to receive the bolt shank 1410 to allow connection to a lower portion 1404 that engages a slot 2006 in the rail 2000. The plate 1500 is preferably made from a durable, yet light metal. Ramped guides 1523 facilitate movement of module frames onto the top surface 1522 of the plate 1500. Runners 1502 and the ramped guides 1523 cooperate with the rail 2000 to prevent the plate 1500 from rotating about the bolt shank 1410. The plate 1500 may be made of stamped steel providing a low friction surface for a second module frame to slide across or rotate across during rock-in installation as shown in FIG. 30(c) until fully clamped between the bottom surface 1414 and the top surface 1522. For this purpose, the plate 1500 rests on the top section of the rail 2000 above a channel 2006. The plate 1500 includes a conical-shaped raised portion 1506, which is open at the top and engages the first module frame F1 to provide a ground bonding connection. The plate 1500 also includes triangle-shaped raised portions 1504, which engage the second module frame F2 to provide a ground bonding connection. The raised portions 1504 are tapered, with the highest part of the raised portion being closest to the through hole 1515. This taper of the raised portions 1504 allows minimal resistance to the second module frame F2 during rock-in installation. Prior to rock-in installation of the second module frame, the first module frame F1 is installed and clamped between the bottom surface 1414 and the top surface 1522 by tightening the bolt 1406 to the desired torque (50-200 in-lb). Therefore, during rock-in installation of the second module frame F2, and after rock-in installation, a clamping force will be exerted on the second module frame F2 between the bottom surface 1414 and the top surface 1522.

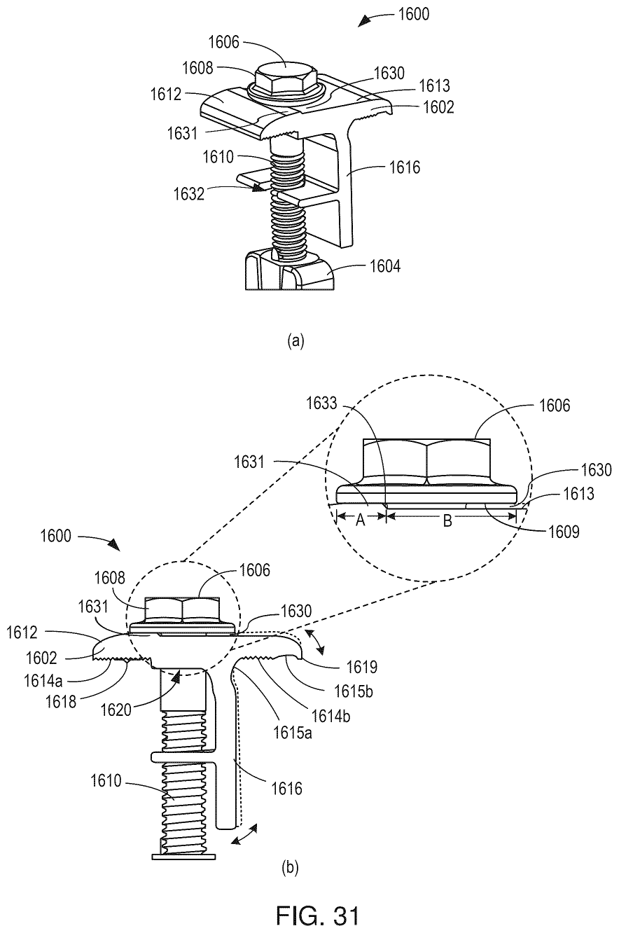

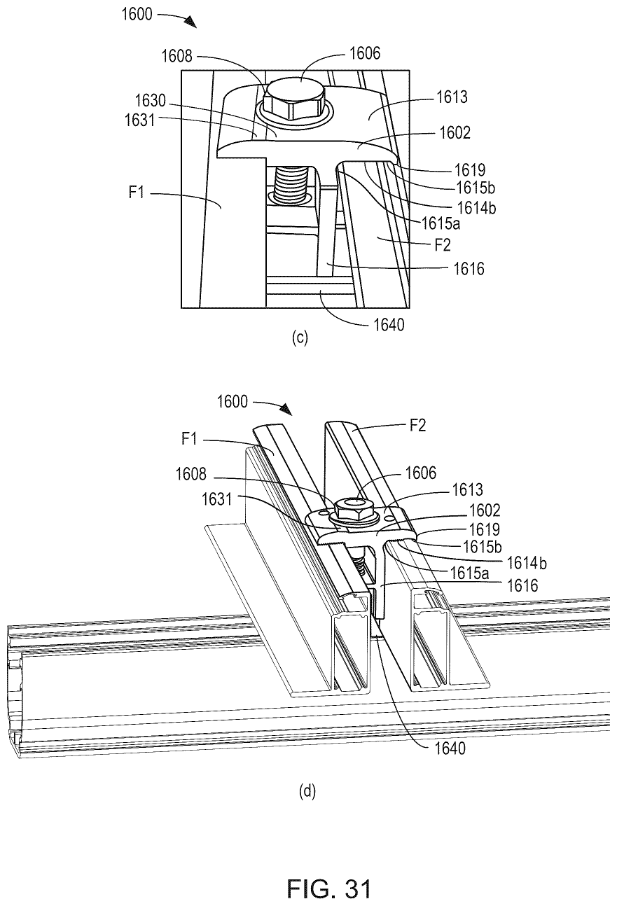

Turning now to FIGS. 31(a)-(d), another embodiment of a mid-clamp 1600 is shown. The mid-clamp 1600 is configured to cooperate with open-top rails like the Aire® rail and is similar to the clamp 200 shown in FIGS. 4 and 5. The clamp 1600 has an upper clamp portion 1602, a central clamp portion 1620, and a lower clamp portion 1604. In other embodiments, the lower clamp portion 1604 could be configured to cooperate with outside clicking rails or inside clicking rails. A fastener 1606 having a head 1608 and a shank 1610 connects the upper clamp portion 1602 with the lower clamp portion 1604. The fastener head 1608 has a round horizontal bottom surface 1609. The upper clamp portion 1602 has a top surface 1612, bottom surfaces 1614a and 1614b which have serrations for engaging with the module frames, a ground bonding pin 1618, and a leg 1616. Bottom surfaces 1614a and 1614b are higher than the central portion 1620 of the upper clamp portion 1602. Additionally, the upper clamp portion 1602 has cutouts 1615a and 1615b to provide added clearance for the upper corners of the second module frame F2 to aid in inserting and rocking the frame into the space between the bottom surface 1614b and top surface of the rail 1640. Cut out 1615a may be located in the vertical leg 1616 near the bottom surface 1614b. Cut out 1615b may be located in the bottom surface 1614b near the distal end and be terminated by a downwardly extending tip 1619 that may extend beyond the bottom surface 1614b as shown.

Referring again to FIGS. 31(a)-(d), the upper clamp portion 1602 has an open slot 1632 which receives and provides clearance around shank 1610, a raised flat portion 1631 which contacts the fastener head 1608 bottom surface 1609, and a lowered flat portion 1613 which does not contact the fastener head 1608 bottom surface 1609 when the bottom surfaces 1614a and 1614b and lowered flat portion 1613 are horizontal with respect to the rail 1640. The upper clamp portion 1602 also includes a step-down transition 1633 between the raised flat portion 1631 and lowered flat portion 1613. The step-down transition 1633 may be angled or entirely vertical and creates a dividing line between the raised flat portion 1631 and lowered flat portion 1613. Dimension A shows the distance from the outer edge of the fastener head 1608 to the step-down transition 1633, and dimension B shows the distance from the opposing outer edge of the fastener head 1608 to the step-down transition 1633. The ratio of dimensions A and B may be in the range of A:B=1:7 to A:B=1:1. For example, step-down transition 1633 may be located half-way between the outer edge of the fastener head 1608 and the outer surface of the fastener shank 1610 (e.g., A:B=1:7). Step-down transition 1633 may be aligned with the center of the fastener shank 1610 (e.g., A:B=1:1). Step-down transition 1633 may also be located anywhere between the two aforementioned locations. The lowered flat portion 1613 may be 0.01 inches to 0.03 inches lower than the raised flat portion 1631 at the step-down transition 1633. When the bottom surfaces 1614a and 1614b and lowered flat portion 1613 are horizontal with respect to the rail 1640 there is a gap 1630 between the lowered flat portion 1613 and fastener head 1608 bottom surface 1609. The gap 1630 may be 0.01 inches to 0.03 inches. The open slot 1632 and lowered flat portion 1613 allow the clamp 1600 to tip or tilt during the rock-in installation of the second module frame F2. The clamp 1600 is able to tip or tilt so that the leg 1616 is at an angle past vertical, and the bottom surfaces 1614a and 1614b and lowered flat portion 1613 are at an angle past horizontal with respect to the rail 1640, until the lowered flat portion 1613 contacts the fastener head 1608 bottom surface 1609. Prior to rock-in installation of the second module frame F2, the first module frame F1 is installed and clamped between the bottom surface 1614a and the top surface of the rail 1640 by tightening the fastener 1606 to the desired torque (50-200 in-lb) as shown in FIG. 31(c). Therefore, during rock-in installation of the second module frame F2, the tipping or tilting motion of the clamp 1600 helps to relieve stress and friction on the second module frame F2, while still exerting a clamping force between the bottom surface 1614b and the top surface of the rail 1640 on the second module frame F2 once fully installed and horizontal to the rail 1640.

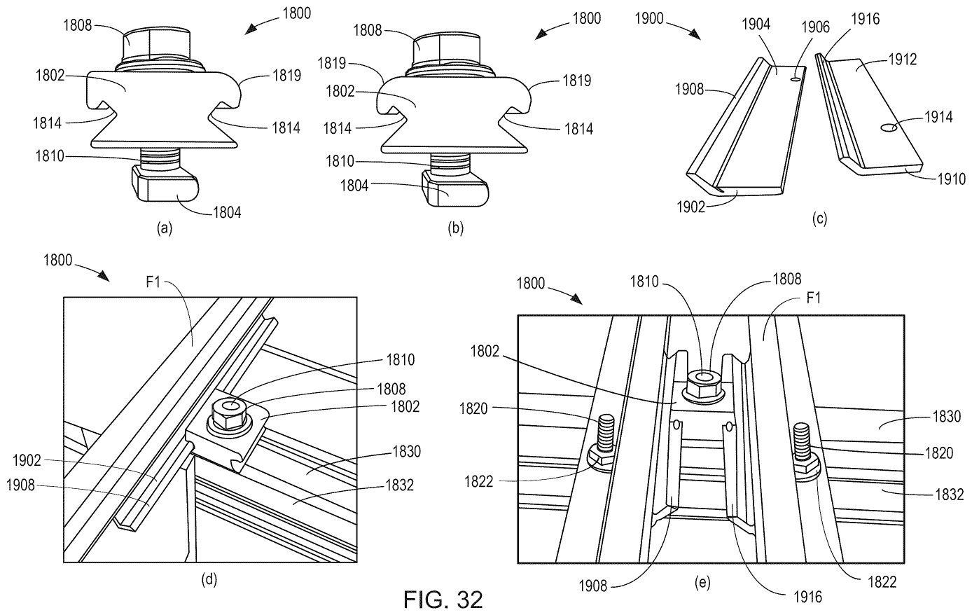

FIGS. 32(a)-(e) illustrate another embodiment of a mid-clamp 1800. The mid-clamp 1800 is configured to cooperate with open-top rails having a slot and utilizes mounting strips 1900 which attach to module frames. The clamp 1800 has an upper clamp portion 1802, a threaded shank 1810, and a lower clamp portion 1804 which engages with a slot 1830 in the rail 1832. A nut 1808 is threaded onto the shank 1810 above the upper clamp portion 1802 and is used to secure the clamp to the rail 1832. Open slots 1814 are configured to receive the mounting strips 1900. As shown in FIG. 32(a), one side of the clamp 1800 includes a rounded portion 1819 to provide clearance between the second module frame F2 and the upper clamp portion 1802 during rock-in installation. Alternatively, as shown in FIG. 32(b), both sides of the clamp 1800 may include a rounded portion 1819. The first mounting strip 1902 is configured for attachment to the first module frame F1, for example by using a bolt 1820 and nut 1822. The top surface 1904 of the mounting strip 1902 contacts the bottom surface of the first module frame F1 when the mounting strip is attached. A through hole 1906 allows a bolt 1820 and nut 1822 to attach the first mounting strip 1902 to the first module frame F1. An upwardly extending edge 1908 is configured to cooperate with an open slot 1814 in the upper clamp portion 1802. The second mounting strip 1910 is configured for attachment to the second module frame F2, for example by using a bolt 1820 and nut 1822. The top surface 1912 of the mounting strip 1910 contacts the bottom surface of the second module frame F2 when the mounting strip is attached. A through hole 1914 allows a bolt 1820 and nut 1822 to attach the second mounting strip 1910 to the second module frame F2. An upwardly extending edge 1916 is configured to cooperate with an open slot 1814 in the upper clamp portion 1802. Prior to rock-in installation of the second module frame F2, the first module frame F1 mounting strip 1902 is installed and clamped between the upwardly extending edge 1908 of the mounting strip 1902 and the top surface of the rail 1832 by tightening the nut 1808 to the desired torque (50-200 in-lb), thereby clamping the first module frame F1 to the top surface of the rail 1832 as shown in FIG. 32(d). During rock-in installation of the second module frame F2 with mounting strip 1910 attached, the upwardly extending edge 1916 cooperates with the open slot 1814 to allow a rotating or rocking-in motion of the module frame until fully installed and horizontal to the rail 1832 as shown in FIG. 32(e).

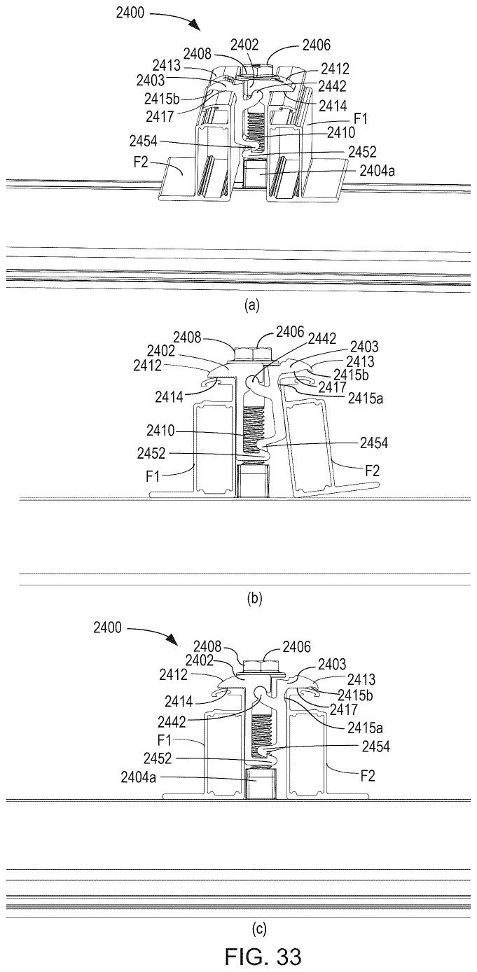

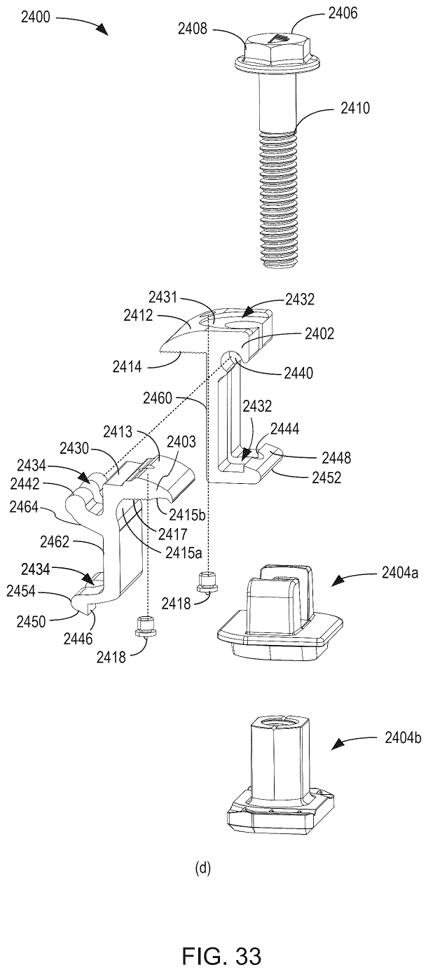

Referring now to FIGS. 33(a)-(d) another embodiment of a mid-clamp 2400 is shown installed on a rail. The mid-clamp 2400 is configured to cooperate with open-top rails like the Aire® rail. The mid-clamp 2400 has a fixed portion 2402 and a movable portion 2403 which is pivotably connected to the fixed portion 2402 by a cylindrical shaped hinge. The cylindrical shaped hinge includes a cutout 2440 on the fixed portion 2402 and a cylinder-shaped distal end 2442 on the arm 2464 of the movable portion 2403, which is similar to a ball and socket arrangement, however only rotatable about one axis. The fixed portion 2402 is secured to the rail with a bolt 2406 having a head 2408, a shank 2410, and lower portions 2404a and 2404b which engage a slot in the rail. The fixed portion 2402 includes a recessed portion 2431 to receive the bolt head 2408, a top surface 2412, bottom surface 2414, leg 2460, a cutout 2432 to allow the bolt shank 2410 to pass therethrough, and a ground bonding pin 2418. The fixed portion 2402 also includes a catch arrangement which includes a vertical flat surface 2444, ramped portion 2448, and a rounded portion 2452. The movable portion 2403 includes a top surface 2413, recessed surface 2430, bottom surface 2417, cutouts 2415a and 2415b, leg 2462, a cutout 2434 to allow the bolt shank 2410 to pass therethrough, and a ground bonding pin 2418. The movable portion 2403 also includes a catch arrangement which includes a vertical flat surface 2446, ramped portion 2450, and a rounded portion 2454.

Referring again to FIGS. 33(a)-(d), the movable portion 2403 cooperates with the fixed portion 2402 to allow a second module frame F2 to be installed with a rock-in motion. Prior to installation of the second module frame F2, a first module frame F1 is installed between the bottom surface 2414 of the fixed portion 2402 and the rail by tightening the bolt 2406 to the desired torque (50-200 in-lb) as shown in FIG. 33(b). Once the first module frame F1 is installed, the clamp movable portion 2403 can freely rotate upwards until the recessed surface 2430 contacts the bolt head 2408, and freely rotate downwards until the catch ramped portion 2450 contacts the opposing catch ramped portion 2448 of the fixed portion 2402. Initially, during installation of the second module frame F2, a gap may be present between the top of the module frame and bottom surface 2417 as shown in FIG. 33(b). During rock-in installation of the second module frame F2, a lateral force is applied to the leg 2462, which encourages the catch ramped portion 2450 to slide on the opposing catch ramped portion 2448 towards the leg 2460 of the fixed portion 2402. Once the movable portion 2403 begins to rotate, the bottom surface 2417 may engage the top of the second module frame F2. Cutouts 2415a and 2415b provide added clearance for the upper corners of the second module frame F2 to aid in inserting and rocking the frame into the space between the bottom surface 2417 and the rail. While rocking in the second module frame F2, forces are applied which overcome the friction between the catch surface 2450 and opposing catch surface 2448, which causes the movable portion to rotate until the catch vertical flat surface 2446 engages the opposing catch vertical flat surface 2444 as shown in FIG. 33(c). Once the catch vertical flat surfaces 2446 and 2444 are engaged, a clamping force is applied to the second module frame F2 between the bottom surface 2417 and the top of the rail. Upward force from the clamping force is directed exclusively into the cylindrical shaped hinge.

Friction between the module and the rail may impact the operation of the system according to the present invention. Anodizing the various parts, such as the rail itself, the ledges 321b, 922b 1021, 3006, or plates 500, 700, 1300, 1500 can help reduce this friction. Forming the rail itself, or the various ledges or the friction plates out of a material that is relatively harder than the module frames F also reduces friction and facilitates the rocking-in process. It will be apparent in light of the above disclosure to those skilled in the art, that the clamp will be designed to work within a certain torque range. The clamp may not allow a module to be inserted if the torque is too high, or the module may not be sufficiently held if the torque is too low. The appropriate torque range varies with rail and clamp constructions and materials.

The rocking-in installation of modules on railed systems is challenging because the system and method allows for a prepositioning of the clamp bottom surfaces 14, 114, 214, 214, 414, 614, 914, 1014, 1114, 1214, 1414, 1614, 3014 at a distance from the rails, ledges or friction plates that is less than the thickness or height of the module frames F. As the module is tilted the distance from the rail, ledge or friction plate to the highest point of the module frame is reduced and this enables the frame to be inserted under the bottom surface of the upper clamp portion. However, as the module is rotated down the distance from the rail, ledge or friction plate to the highest point of the module frame is increased to a distance above the height/thickness of the frame F when it is in its final horizontal installed position. Thus, it is valuable to facilitate the rocking-in to allow some relief of upward pressure exerted by the rotating frame. The present invention includes a variety of facilitating structures and features. These features include the rock-in pockets present in several designs of the lower clamp portions which include ledges. Another facilitating feature is the rock-in pockets created by the friction plates. The cut outs 115a, 115b are also rock-in pockets in the upper clamp portions as described above. The angles between the bottom surfaces and the legs also can act as facilitating structures and some embodiments allow for a gap above an upwardly extending leg which acts as a cut out and/or rock-in pocket to facilitate the rocking-in process.

Various rails, module frames, materials and clamps can affect the operation of the rocking-in method. Thus the required torque, the optimal friction reduction, design of the friction reducing structures including the raised portions and rock-in pockets as well as the various cut outs and rock-in pockets, and other features can be combined in various clamps and systems as needed. The combinations of clamps with ledges and friction plates and various cut outs and rock-in pockets are not limiting and any conceivable combination is understood and considered herein.

1. A clamp for attaching a solar panel module frame to a rail, comprising:
an upper clamp portion;
a lower clamp portion;
a fastener connecting the upper clamp portion with the lower clamp portion,
the upper clamp portion having a top surface and a bottom surface,
at least a portion of the bottom surface being coincident with a plane which is inclined with respect to horizontal,
the lower clamp portion being configured to engage with a rail,
wherein when a first solar panel module frame is inserted between the upper clamp portion and the rail, and said fastener is tightened to a desired torque, the bottom surface of the upper clamp portion tilts slightly so that said plane moves to a slightly declined orientation with respect to horizontal, creating a clearance below the declined bottom surface, which clearance is less than a height of the second solar module frame;
and further wherein when the second solar panel module frame is inserted between the upper clamp portion and the rail on a side of said fastener which is opposite the first solar panel module frame, said solar panel module frame exerts an upward force on the upper clamp portion, thereby bringing said plane into coincidence with horizontal, and
the compressive forces of the upper clamp portion and the height of the second solar module frame cooperate to secure the second solar panel module frame in the clamp without further tightening of the fastener.

2. The clamp of claim 1, further including a leg extending downward from said bottom surface.

3. The clamp of claim 1, wherein an angle at which said plane is inclined with respect to horizontal is between 0.25° and 7°.

4. The clamp of claim 1, wherein said second module frame rests directly on said rail after said insertion between the upper clamp portion and the rail.

5. The clamp of claim 1, wherein said bottom surface is provided with serrations and a bonding pin.

6. The clamp of claim 1, further including a friction plate which rests on or above said rail.

7. The clamp of claim 6, wherein said friction plate includes a cross member which defines a pocket between the clamp and the cross member.

8. The clamp of claim 6, wherein said friction plate has a raised section.

9. The clamp of claim 8, wherein said raised section is domed shaped.

10. The clamp of claim 8, wherein said raised section engages with a bottom surface of the second module frame, when said second module frame is inserted in said clearance between said friction plate and the bottom surface of said upper clamp portion.

11. The clamp of claim 8, further including a pocket defined between the raised portion and the lower clamp portion.

12. The clamp of claim 1, wherein said rail is open-topped, and further including a ledge on the bottom clamp portion which traverses the width of the opening in the top of the rail.

13. The clamp of claim 12, wherein said second solar module frame engages said ledge when the second solar module frame is inserted in said clearance below the upper clamp portion.

14. The clamp of claim 13, wherein said rail has outer top edges on either side of said ledge, and at least a part of a top surface on said ledge is above said outer top edges of the rail.

15. The clamp of claim 14, further including a pocket defined in the top surface of said ledge, near a proximal end of said ledge.

16. The clamp of claim 8, further including standoffs on opposite sides of a distal end of said plate.

17. The clamp of claim 7, further including runners on opposite sides of said plate and paralleling said rail.

18. The clamp of claim 1, wherein said lower clamp portion has a tapered shape.

19. A clamp for attaching a solar panel module frame to a rail, comprising:
an upper clamp portion;
a lower clamp portion;
a fastener connecting the upper clamp portion with the lower clamp portion,
the upper clamp portion having a top surface and a bottom surface, and further having male and female portions;
a resilient element positioned in said female portion adjacent and in contact with said male portion;
the lower clamp portion being configured to engage with a rail,
wherein when a first solar panel module frame is inserted between the upper clamp portion and the rail, and said fastener is tightened to a desired torque, the bottom surface of the male portion of the upper clamp portion moves to a position creating a clearance below the bottom surface, which clearance is less than a height of the second solar module frame;
and further wherein when the second solar panel module frame is inserted between the upper clamp portion and the rail on a side of said fastener which is opposite the first solar panel module frame, said solar panel module frame exerts an upward force on the male portion of the upper clamp portion, thereby causing an equal and opposite force imparted by said resilient element, and
the compressive forces of the male portion of the upper clamp portion and the height of the second solar module frame cooperate to secure the second solar panel module frame in the clamp without further tightening of the fastener.

20. A method for attaching solar panel modules to a rail, using a mid-clamp, comprising the steps of:
(a) securing a first solar panel module to a rail at a first module edge frame;
(b) positioning a mid-clamp on said first solar panel at a second module edge frame opposite said first module edge frame;
(c) tightening said mid-clamp to a desired torque, thereby securing said mid-clamp to the rail and tilting a mid-clamp surface opposite said rail to create a clearance between said surface and said rail, said clearance being more narrow than a height of said second module edge frame;
(d) inserting a second solar panel module into said clearance, by rocking-in a third module edge frame so that said third module edge frame exerts an upward force on said mid-clamp surface, thereby bringing said surface into a plane which is coincident with horizontal, and
the compressive forces of the mid-clamp surface and the height of the third module edge frame cooperating to secure the second solar panel module edge frame in the mid-clamp without further tightening of the mid-clamp.

21. The method of claim 20, wherein said tightening is carried out using a fastener on said mid-clamp.

22. The method of claim 20, wherein, prior to step (c), said mid-clamp surface is inclined with respect to horizontal, and after step (c), said mid-clamp surface is declined with respect to horizontal.

23. The method of claim 20, wherein said desired torque is in the range of 50-200 inch-pounds.

24. The method of claim 22, wherein an angle at which said surface is inclined and/or declined with respect to horizontal is between 0.25° and 7°.
